(19) United States
(12) Patent Application Publication
(10) Pub. No.: US 2005/0234758 A1
(43) Pub. Date: Oct. 20, 2005

(54) Task progress management method, task progress management device and program

(75) Inventor: Keita Nishi, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/105,499

(22) Filed: Apr. 14, 2005

(30) Foreign Application Priority Data
Apr. 15, 2004 (JP) 2004-120510

(51) Int. Cl. G06F 17/60

(52) U.S. Cl. 705/8

(57) ABSTRACT

In estimation of a task scale, information on the start and completion dates of a task, non-operation information such as holidays and information on man-days of other task plans are used to attain high-precision estimation. The number of man-days is estimated from the task scale for the next week by referring to the productivity of the task plan, the productivity of the task actual results and the maximum, minimum and average of productivity of the past task actual results to improve the estimation precision. The scheduled completion date is predicted from the information of the task scale and the number of man-days planned for the next week and the task actual results, so that delay is expressed quantitatively.

### CROSS-REFERENCE TO RELATED APPLICATIONS

This application claims priority under 35 U.S.C. §119 on Patent Application No. 2004-120510 filed in Japan on Apr. 15, 2004, the entire contents of which are hereby incorporated by reference.

### BACKGROUND OF THE INVENTION

The present invention relates to a method for managing the progress status of each task of a project and a management device for implementing this method.

Conventional task progress management includes estimating the task scale (task particulars), the number of man-days, the start date and the completion date, recording the actual results of the task scale and the number of man-days periodically, and grasping the progress rate of the task scale as quantitative information and problems related to the progress as qualitative information, to thereby enable review of the task plan at any time. Actually, in an ongoing project, a staff member takes charge of a plurality of tasks and performs progress management for each task. For smooth proceeding of the project, also, it has been recognized necessary to, not only check the task progress and review the task plan, but also predict the future considering the actual results of the progress up to the current date and determine whether or not the task will be completed by its completion date. In the conventional progress management method, future prediction is performed in the following manner. A person in charge records the actual results of the progress (task scale and the number of man-days) periodically and also extracts a problem occurring in proceeding of the task. The person updates the task completion date based on his or her qualitative experience and sense, and the project manager verifies the validity thereof. In recent years, with increase in the scale and complexity of projects, the number of tasks one person takes charge of increases. It is not a rare case, therefore, to allow simultaneous proceeding of a plurality of tasks. Under this situation, the technique of task progress management has been improved. That is, using a once-estimated task plan as a basis, the actual results of the task for a fixed period (for example, for a week) are recorded, and the task scale for the next fixed period is estimated in consideration of the remaining task scale. Also, using the estimation of the task scale, review of the progress rate during the period of the actual results, check of the progress rate attainable during the next fixed period and the like are performed, to thereby review the relationship between the remaining task scale and the scheduled completion date. In this way, reliable progress management has been made.

FIG. 38 is a flowchart showing a conventional procedure of updating the task completion date based on records of the actual results and the plan for each fixed period (week). In the conventional progress management technique shown in FIG. 38, the task scale, the number of man-days, the start date, the completion date, and the weekly-based plan and actual results for each task are managed in the form of a table. A task higher in priority is selected from the table. For the selected task, the actual task scale in this week and the planned task scale for the next week are recorded, and also the actual number of man-days in this week and the planned number of man-days for the next week are recorded, to grasp the progress rate, the remaining task scale and the like and thus update the scheduled task completion date. The recording of the actual results and the plan and the updating of the completion date are repeated until all the tasks listed in the table have been subjected to the recording and the updating. The project manager verifies the validity of the future prediction by checking this table.

### SUMMARY OF THE INVENTION

However, the conventional progress management technique described above largely depends on the qualitative experiences and senses of the person in charge and the project manager. This may cause large variations in estimation results depending on the estimation ability of the person in charge. Also, since the planned task scale and the planned number of man-days for a week are derived from the actual results in the preceding week, the task progress depends on the task pitch of the person in charge, and this tends to cause a problem in the adherence to the task completion date (for example, the delivery date). For example, in the event that a task is completed on the verge of its scheduled completion date and a problem is found when the task results are checked after the completion, part of the task may have to be done over. In such a case, the task may only be completed after the scheduled completion date, causing task delay. Moreover, in the conventional technique, when one person must take charge of a plurality of tasks proceeding simultaneously, the way of prioritizing the tasks depends on this person. This may cause such events that the tasks are wrongly prioritized, an omission occurs in a task plan, and sufficient consideration is not given to other task plans proceeding simultaneously. Hence, the estimation precision of the planned task scales is not sufficiently high. In the conventional technique, also, in updating the task completion date, the completion date is predicted based on the relationship between the actual progress rate and the completion date. In the prediction, therefore, no consideration is given to jobs other than the project and holidays, and thus the prediction precision of the completion date is unreliable.

An object of the present invention is providing a task progress management method that can improve the estimation precision of a task independently of the estimation ability of a person in charge, and a task progress management device for implementing such a method.

The first task progress management device of the present invention is a task progress management device for managing the progress status of a selected task, including: an entry section for entering a task plan and task actual results of an individual; a storage section for storing the task plan, the task actual results and non-operating man-day information including holiday information; a computation section including: a reference man-day computation part for computing the number of man-days available in a first period starting from termination of the entry of information in the entry section and the number of man-days available in a second period after the passing of the first period until a completion date of the selected task, based on at least the task plan, the task actual results and the non-operating man-day information; and a reference task scale computation part for estimating a reference task scale in the first period from a rate of the number of man-days available in the first period to the number of man-days available in the second period and the remaining task scale required until completion of the task; a display section for displaying the information entered in the entry section and the computation results in the computation section; and a control section for executing write of information to the storage section, read of information from the storage section and transfer of the computation results in the computation section to the display section.

According to the device described above, the non-operating man-day information is added in determination of the numbers of man-days available in the first period and the second period, and thus more precise task estimation can be made. Also, since the reference task scale in the first period is determined from the task plan and the number of available man-days, the task plan can be estimated objectively without relying on the experience and sense of the person in charge.

The second task progress management device of the present invention is a task progress management device for managing the progress status of a selected task, including: an entry section for entering a task plan and task actual results of an individual, the task plan including a task category, a task start date, a task completion date, a total task scale and the total number of man-days of the selected task, the task actual results including a task scale and the number of man-days completed every fixed period; a storage section for storing the task plan and the task actual results, as well as productivity of the task plan calculated from (the total task scale)/(the total number of man-days), and a cumulative task scale and the cumulative number of man-days accumulated for each task category; a computation section including a reference man-day computation part for computing the maximum and minimum of productivity from the task scale and the number of man-days completed in each of fixed periods, computing the productivity of the task plan from the total task scale and the total number of man-days, computing the average of productivity from the cumulative task scale and the cumulative number of man-days, and computing latest actual productivity from the task scale and the number of man-days completed in the latest one of the fixed periods, the computation section also computing the number of man-days for the next fixed period using the maximum and minimum of productivity, the average of productivity, the productivity of the task plan and the latest actual productivity; a display section for displaying the information entered in the entry section and the computation results in the computation section; and a control section for executing write of information to the storage section, read of information from the storage section, and transfer of the computation results in the computation section to the display section.

According to the device described above, it is possible to refer to a plurality of numbers of man-days for various types of productivity derived from the task plan and the task actual results of the person in charge. Hence, the task plan can be made without relying on the experience and sense of the person in charge.

The third task progress management device of the present invention is a task progress management device for managing the progress status of a selected task, including: an entry section for entering a task plan and task actual results of an individual, the task plan including a total task scale and the total number of man-days of the selected task, the task actual results including a task scale and the number of man-days completed every fixed period; a storage section for storing the task plan and the task actual results, as well as the cumulative number of man-days and a cumulative task scale of the selected task, and a task scale progress rate determined from the cumulative task scale and the total task scale; a computation section including a predicted task completion date computation part for calculating the number of man-days required until completion of the selected task from the cumulative number of man-days of the task and the task scale progress rate: and predicting a scheduled completion date of the task based on the calculation result; a display section for displaying the information entered in the entry section and the computation results in the computation section; and a control section for executing write of information to the storage section, read of information from the storage section, and transfer of the computation results in the computation section to the display section.

According to the device described above, the task completion date can be predicted objectively based on the task actual results of the person in charge and the task plan. Hence, limit management can be made more easily and delay of a task can be detected more easily than conventionally done.

The first task progress management method of the present invention is a task progress management method using a task progress management device including: an entry section, a storage section for storing information entered in the entry section; a computation section for computing reference information related to a plan of a selected task using the information entered in the entry section or information stored in the storage section; a display section for displaying the information entered in the entry section and the computation results in the computation section; and a control section for executing write of information to the storage section, read of information from the storage section, and transfer of the computation results in the computation section to the display section, the method including the steps of: (a) entering a task plan including a start date, a completion date and a total task scale of the selected task, task actual results and non-operating man-day information including holiday information in the entry section; (b) computing the number of man-days available in a first period starting from termination of entry of information in the entry section, based on the task plan and the non-operating man-day information, in the computation section; (c) computing the number of man-days available in a second period after the passing of the first period until the completion date of the selected task, based on the task plan and the non-operating man-day information, in the computation section; and (d) estimating a reference task scale in the first period from a rate of the number of man-days available in the first period to the number of man-days available in the second period and the remaining task scale until termination of the selected task, in the computation section.

According to the method described above, the reference task scale is determined based on the number of man-days considering jobs other than the project and holidays. Hence, task estimation can be made more precisely than conventionally done.

The second task progress management method of the present invention is a task progress management method using a task progress management device including: an entry section, a storage section for storing information entered in the entry section; a computation section for computing reference information related to a plan of a selected task using the information entered in the entry section or information stored in the storage section; a display section for displaying the information entered in the entry section and the computation results in the computation section; and a control section for executing write of information to the storage section, read of information from the storage section, and transfer of the computation results in the computation section to the display section, the method including the steps of: (a) entering a task plan including a task category, a start date, a completion date, a total task scale and the total number of man-days of the selected task; (b) entering task actual results of an individual including a task scale and the number of man-days completed every fixed period; (c) writing a cumulative task scale and the cumulative number of man-days accumulated for each task category in the storage section with the entry of the task scale and the number of man-days completed every fixed period; (d) computing productivity of the task plan calculated from (the total task scale)/(the-total number of man-days), the maximum and minimum of productivity from the task scale and the number of man-days completed in each of fixed periods, the average of productivity from the cumulative task scale and the cumulative number of man-days, and latest actual productivity from the task scale and the number of man-days completed in the latest one of the fixed periods, in the computation section; and (e) computing the number of man-days for the next fixed period using the computation results obtained in the step (d), in the computation section.

According to the method described above, the number of man-days for the next fixed period can be determined by referring to a plurality of numbers of man-days for different types of productivity derived from the task plan and the task actual results. Hence, the task plan can be made without relying on the experience and sense of the person in charge. Also, the number of man-days for the next fixed period can be easily corrected according to the status of the task.

The third task progress management method of the present invention is a task progress management method using a task progress management device including: an entry section, a storage section for storing information entered in the entry section; a computation section for computing reference information related to a plan of a selected task using the information entered in the entry section or information stored in the storage section; a display section for displaying the information entered in the entry section and the computation results in the computation section; and a control section for executing write of information to the storage section, read of information from the storage section, and transfer of the computation results in the computation section to the display section, the method including the steps of: (a) entering a task plan including a start date, a completion date, a total task scale and the total number of man-days of the selected task and non-operating man-day information including holiday information in the entry section; (b) entering task actual results of an individual including the task scale and the number of man-days completed every fixed period; (c) computing a task scale progress rate from a cumulative task scale of the selected task and the total task scale, in the computation section; and (d) calculating the number of man-days required until completion of the selected task from the cumulative number of man-days of the selected task and the task scale progress rate and predicting a scheduled completion date of the task based on the computation result, in the computation section.

According to the method described above, the task completion date can be predicted objectively based on the task actual results of the person in charge and the task plan. Hence, limit management can be made more easily and delay of the task can be detected more easily than conventionally done.

The first program of the present invention is a program for enabling a computer to execute a function of a task progress management device including: an entry section, a storage section for storing information entered in the entry section; a computation section for computing reference information related to a plan of a selected task using the information entered in the entry section or information stored in the storage section; a display section for displaying the information entered in the entry section and the computation results in the computation section; and a control section for executing write of information to the storage section, read of information from the storage section, and transfer of the computation results in the computation section to the display section, the function to executed by the computer including the steps of: (a) entering a task plan including a start date, a completion date and a total task scale of the selected task, task actual results and non-operating man-day information including holiday information in the entry section; (b) computing the number of man-days available in a first period starting from termination of entry of information in the entry section based on the task plan and the non-operating man-day information; (c) computing the number of man-days available in a second period after the passing of the first period until the completion date of the selected task, based on the task plan and the non-operating man-day information; and (d) estimating a reference task scale in the first period from a rate of the number of man-days available in the first period to the number of man-days available in the second period and the remaining task scale until termination of the selected task.

According to the program described above, the reference task scale is determined based on the number of man-days considering jobs other than the project and holidays. Hence, task estimation can be made more precisely than conventionally done. Also, compared with implementation of the task progress management device by exclusive hardware, the program can be supplied to users more easily by duplication or via electric circuits.

The second program of the present invention is a program for enabling a computer to execute a function of a task progress management device including: an entry section, a storage section for storing information entered in the entry section; a computation section for computing reference information related to a plan of a selected task using the information entered in the entry section or information stored in the storage section; a display section for displaying the information entered in the entry section and the computation results in the computation section; and a control section for executing write of information to the storage section, read of information from the storage section, and transfer of the computation results in the computation section to the display section, the function to executed by the computer including the steps of: (a) entering a task plan including a task category, a start date, a completion date, a total task scale and the total number of man-days of the selected task; (b) entering task actual results of an individual including a task scale and the number of man-days completed every fixed period; (c) writing a cumulative task scale and the cumulative number of man-days accumulated for each task category in the storage section according to the entry of the task scale and the number of man-days completed every fixed period; (d) computing productivity of the task plan calculated from (the total task scale)/(the total number of man-days), the maximum and minimum of productivity from the task scale and the number of man-days completed in each of fixed periods, the average of productivity from the cumulative task scale and the cumulative number of man-days, and latest actual productivity from the task scale and the number of man-days completed in the latest one of the fixed periods; and (e) computing the number of man-days for the next fixed period using the computation results obtained in the step (d).

According to the program described above, the number of man-days for the next fixed period can be determined by referring to a plurality of numbers of man-days for different types of productivity derived from the task plan and the task actual results. Hence, the task plan can be made without relying on the experience and sense of the person in charge.

The third program is a program enabling a computer to execute a function of a task progress management device including: an entry section, a storage section for storing information entered in the entry section; a computation section for computing reference information related to a plan of a selected task using the information entered in the entry section or information stored in the storage section; a display section for displaying the information entered in the entry section and the computation results in the computation section; and a control section for executing write of information to the storage section, read of information from the storage section, and transfer of the computation results in the computation section to the display section, the function to be executed by the computer including the steps of: (a) entering a task plan including a start date, a completion date, a total task scale and the total number of man-days of the selected task and non-operating, man-day information including holiday information in the entry section; (b) entering task actual results of an individual including the task scale and the number of man-days completed every fixed period; (c) computing a task scale progress rate from a cumulative task scale of the selected task and the total task scale; and (d) calculating the number of man-days required until completion of the selected task from the cumulative number of man-days of the selected task and the task scale progress rate and predicting a scheduled completion date of the task based on the computation result.

According to the program described above, the task completion date can be predicted objectively based on the task actual results of the person in charge and the task plan. Hence, limit management can be made more easily than conventionally done.

### BRIEF DESCRIPTION OF THE DRAWINGS

FIG. 1 is a block diagram showing the entire configuration of a task progress management device of an embodiment of the present invention.

FIG. 2 is a view showing a screen for entry of this week's actual results.

FIG. 3 is a view showing a screen for entry of next week's plan.

FIG. 4 is a flowchart showing a procedure of entering next week's plan in a task progress management method of an embodiment of the present invention.

FIG. 5 is a flowchart showing a procedure of selecting a task higher in priority automatically in the task progress management method of the present invention.

FIG. 6 is a flowchart showing processing of step S51 in FIG. 4.

FIG. 7 is a flowchart showing processing of step S55 in FIG. 4.

FIG. 8 is a flowchart showing processing of step S57 in FIG. 4.

FIG. 9 is a view for demonstrating a method for calculating the task scale for the next week in Specific Example 1 of the task progress management method of the present invention.

FIG. 10 is a view for demonstrating the method for calculating the task scale for the next week in Specific Example 1.

FIG. 11 is a view for demonstrating the method for calculating the task scale for the next week in Specific Example 1.

FIG. 12 is a view for demonstrating the method for calculating the task scale for the next week in Specific Example 1.

FIG. 13 is a view for demonstrating a method for calculating the task scale for the next week in Specific Example 2 of the task progress management method of the present invention.

FIG. 14 is a view for demonstrating the method for calculating the task scale for the next week in Specific Example 2.

FIG. 15 is a view for demonstrating the method for calculating the task scale for the next week in Specific Example 2.

FIG. 16 is a graph for demonstrating a method for calculating the number of man-days for the next week.

FIG. 17 is a graph for demonstrating a method for calculating the number of man-days for the next week.

FIG. 18 is a graph for demonstrating a method for calculating the number of man-days for the next week.

FIG. 19 is a graph for demonstrating a method for calculating the number of man-days for the next week.

FIG. 20 is a graph for demonstrating a method for calculating the predicted task completion date in the task progress management method of the present invention.

FIG. 21 is a graph for demonstrating a method for calculating the predicted task completion date in the task progress management method of the present invention.

FIG. 22 is a view for demonstrating an effect of correction using an operating man-day rate in the task progress management method of the present invention.

FIG. 23 is a view for demonstrating the effect of correction using an operating man-day rate in the task progress management method of the present invention.

FIG. 24 is a view for demonstrating an effect of correction using an operating man-day rate in the task progress management method of the present invention.

FIG. 25 is a view for demonstrating the effect of correction using an operating man-day rate in the task progress management method of the present invention.

FIG. 26 is a view for demonstrating an effect of correction using an operating man-day rate in the task progress management method of the present invention.

FIG. 27 is a view for demonstrating the effect of correction using an operating man-day rate in the task progress management method of the present invention.

FIG. 28 is a view showing an example of operating man-day rate pattern.

FIG. 29 is a view showing another example of operating man-day rate pattern.

FIG. 30 is a view showing yet another example of operating man-day rate pattern.

FIG. 31 is a view showing yet another example of operating man-day rate pattern.

FIG. 32 is a view showing yet another example of operating man-day rate pattern.

FIG. 33 is a view showing yet another example of operating man-day rate pattern.

FIG. 34 is a view for demonstrating an effect of correction using an advancing rate in the task progress management method of the present invention.

FIG. 35 is a view for demonstrating the effect of correction using an advancing rate in the task progress management method of the present invention.

FIG. 36 is a view for demonstrating the effect of correction using an advancing rate in the task progress management method of the present invention.

FIG. 37 is a view for demonstrating the effect of correction using an advancing rate in the task progress management method of the present invention.

FIG. 38 is a flowchart showing a procedure of conventional progress management.

### DESCRIPTION OF THE PREFERRED EMBODIMENTS

Hereinafter, a preferred embodiment of a task progress management device for a project according to the present invention will be described with reference to the accompanying drawings.

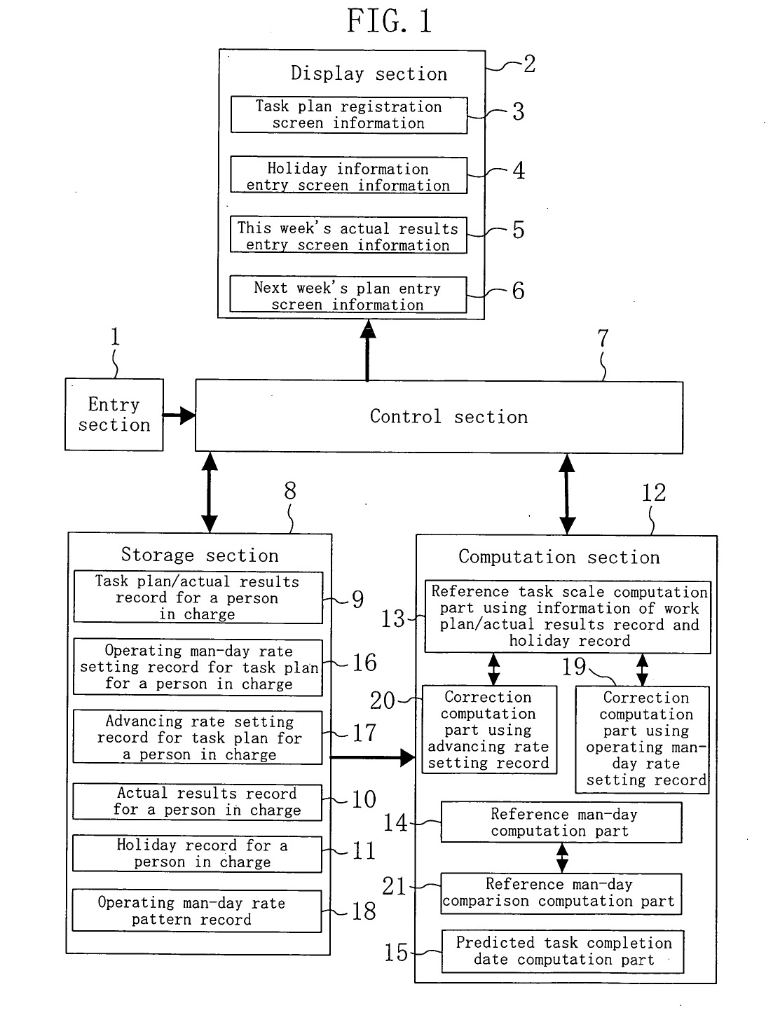

FIG. 1 is a block diagram showing the entire configuration of a task progress management device of an embodiment of the present invention. The task progress management device of FIG. 1 includes: an entry section 1, such as a keyboard, for entering information including a task plan, actual results and instructions; a display section 2 for preparing screen information to be displayed on a display; a storage section 8 having memories for storing entered information such as a task plan, task actual results and non-operating man-day information like holidays; a computation section 12 for computing reference information including estimation of a task; and a control section 7 for controlling the storage section 8, the computation section 12 and the display section 2 based on the information entered by the person in charge. The storage section 8 has records in which information used for estimation of the number of man-days and the task scale has been written. Such records include a task plan/actual results record 9 for the person in charge, an operating man-day rate setting record 16 for a task plan for the person in charge, an advancing rate setting record 17 for a task plan for the person in charge, an actual results record 10 for the person in charge, a holiday record 11 for the person in charge, and an operating man-day rate pattern record 18. The information used for estimation of the number of man-days and the task scale may be entered via the entry section 1. Otherwise, such information may be entered by inserting a recording medium having such information stored therein into the storage section 8, or by copying the data in the recording medium to the storage section 8.

The computation section 12 includes: a reference task scale computation part 13 for computing a reference task scale using the information recorded in the task plan/actual results record 9 and the holiday record 11 (for the person in charge); a first correction computation part 19 for correcting the reference task scale using the information recorded in the operating man-day rate setting record 16; a second correction computation part 20 for correcting the reference task scale using the information recorded in the advancing rate setting record 17; a reference man-day computation part 14; a reference man-day comparison part 21; and a predicted task completion date computation part 15. The display for displaying an image may be a separate unit to be connected to the task progress management device for data entry, or may be incorporated in the display section 2. The illustrated sections of the task progress management device may be implemented by exclusive hardware. Otherwise, the functions of the task progress management device can be implemented by a CPU of a computer executing a software program for progress management.

Hereinafter, a task progress management method using the task progress management device of this embodiment described above will be described.

In entry of a task plan, the entry section 1 notifies the control section 7 of the entry. The control section 7 then instructs the display section 2 to display a task plan registration screen. The display section 2 prepares display information from task plan registration screen information 3 and displays the prepared information on the display. The person in charge enters a task name, a category, a start date, a completion date, a total task scale, total man-days, an operating man-day rate and an advancing rate for a new task plan via the entry section 1. With this entry, the control section 7 stores the entered details in the task plan/actual results record 9, the operating man-day rate setting record 16 for the task plan and the advancing setting record 17 for the task plan, for the person in charge, in the storage section 8. To facilitate entry of the operating man-day rate, some patterns are recorded in advance in the operating man-day rate pattern records 18 in the storage section 8, to enable use of any of such patterns at the entry of the operating man-day rate as an item of the task plan via the entry section 1. Note that in the task progress management method of this embodiment, the “number of operating man-days”, which are the same in meaning as the “number of man-days”, refer to the time used for work expressed in units of days.

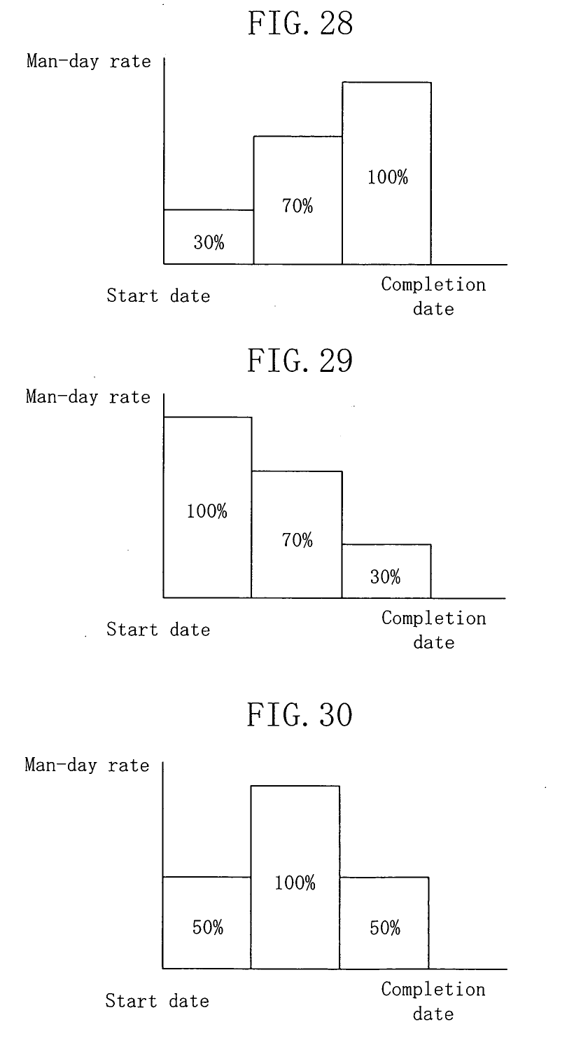

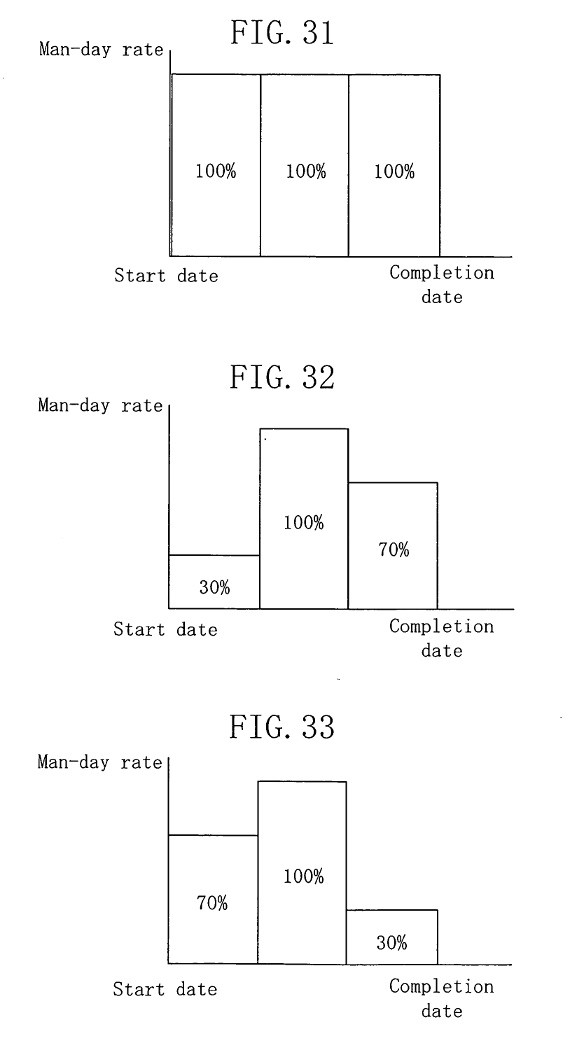

FIGS. 28 to 33 are views showing examples of operating man-day rate patterns. In these patterns, the duration from the task start date to the completion date is divided into a plurality of time periods, and the task scale performed in each time period is weighted. These operating man-day rate patterns will be described later in detail.

In entry of non-operation information such as holidays of the person in charge, the entry section 1 notifies the control section 7 of this entry. The control section 7 instructs the display section 2 to display a holiday information entry screen. The display section 2 prepares display information from holiday information entry screen information 4 and displays the prepared information on the display. The non-operating man-day information such as holidays is stored in the holiday record 11 for the person in charge in the storage section 8.

In entry of weekly task actual results, the entry section 1 notifies the control section 7 of this entry. The control section 7 instructs the display section 2 to display this week's actual results entry screen. The display section 2 prepares display information from this week's actual results entry screen information 5 and displays the prepared information, on the display. The person in charge enters information on the task such as the actual task scale, the actual number of man-days, the start date and the completion date via the entry section 1. With this entry, the control section 7 stores the entered details in the task plan/actual results record 9 and the actual results record 10 for the person in charge in the storage section 8.

In entry of task estimation for the next week, the entry section 1 notifies the control section 7 of this entry. The control section 7 instructs the display section 2 to display next week's plan entry screen. The display section 2 prepares display information from next week's plan entry screen information 6 and displays the prepared information on the display. The person in charge enters information such as the task scale and the number of man-days estimated for the next week and the predicted completion date via the entry section 1. With this entry, the control section 7 stores the entered details in the task plan/actual results record 9 for the person in charge in the storage section 8.

The control section 7 then controls the computation section 12. At the time of selection of estimation-involving work, the control section 7 issues an instruction to the reference task scale computation part 13 for display of a reference value of the task scale. On receipt of the instruction, the reference task scale computation part 13 computes the number of operating man-days (available man-days) for the next week and the number of operating man-days from the week after the next to the completion date. The first correction computation part 19 then corrects the numbers of operating man-days using the operating man-day rate setting record 16. Also, the second correction computation part 20 corrects the numbers of operating man-days using the advancing rate setting record 17. The “advancing rate” as used herein refers to a value set for completing the task earlier than the schedule. With this correction, an allowance for review of the task and the like can be secured.

The reference task scale computation part 13 then computes the task scale to be planed for the next week from the rate of the corrected number of operating man-days for the next week to the corrected number of operating man-days from the week after the next to the completion date, and the computed value is sent to the display section 2 for display.

At the time of entry of the estimated task scale value via the input section 1, the control section 7 issues an instruction to the reference man-day computation part 14 for display of a reference value of the number of man-days. The reference man-day computation part 14 computes a reference value of the number of man-days for the next week from the estimated task scale value for the next week by referring to the maximum, minimum and average of productivity in the task category concerned stored in the actual results record 10 for the person in charge. Also, the reference man-day computation part 14 computes a reference value of the number of man-days for the next week from the estimated task scale value for the next week by referring to the productivity of the task actual results in this week and the productivity of the plan stored in the task plan/actual results record 9 for the person in charge. The reference man-day comparison computation part 21 computes productivity data (productivity data of the task plan if the task has not yet started) from the corrected number of operating man-days from the next week to the completion date and the remaining task scale. Also, the reference man-day comparison computation part 21 computes the number of man-days for comparison from the computed productivity data and the planned task scale for the next week. If the number of man-days computed by the reference man-day computation part 14 is smaller than the number of man-days for comparison, the display section 2 (or the display) displays the reference number of man-days in a normal manner (for example, in white lettering). If the number of man-days computed by the reference man-day computation part 14 is greater than the number of man-days for comparison, the display section 2 displays the reference number of man-days in a color different from the normal color as warning.

At the time of entry of the estimated number of man-days via the input section 1, the control section 7 issues an instruction to the predicted task completion computation part 15 for display of a predicted task completion date as reference. The computed value from the predicted task completion date computation part 15 is displayed by the display section 2 as the predicted task completion date. Thus, the computation section 12 executes high-precision computation using the information stored in the storage section 8.

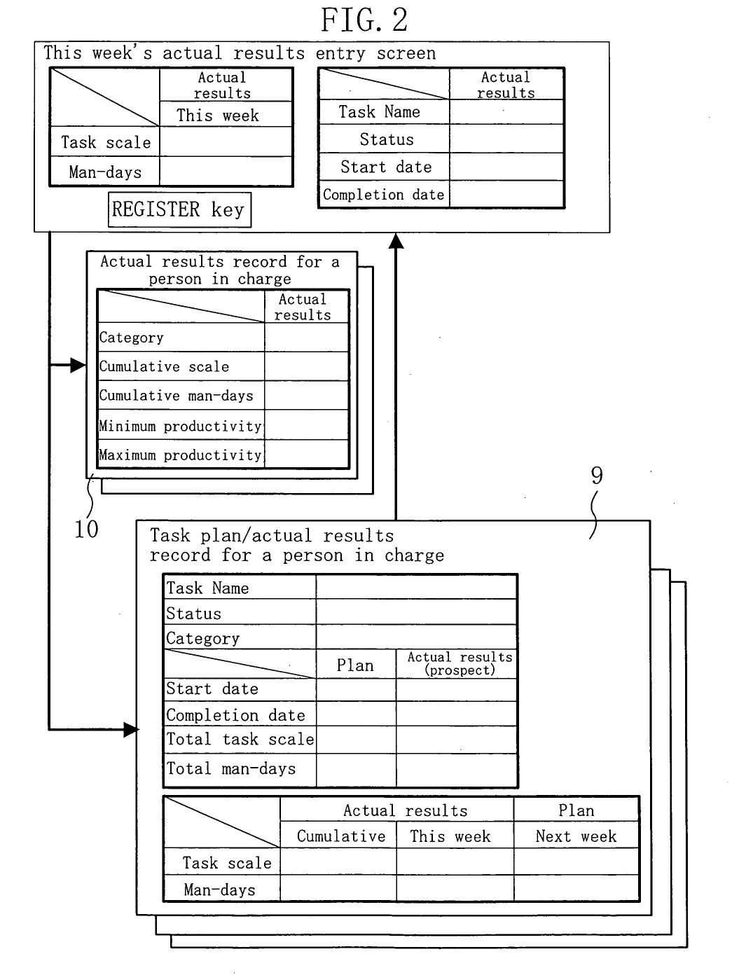

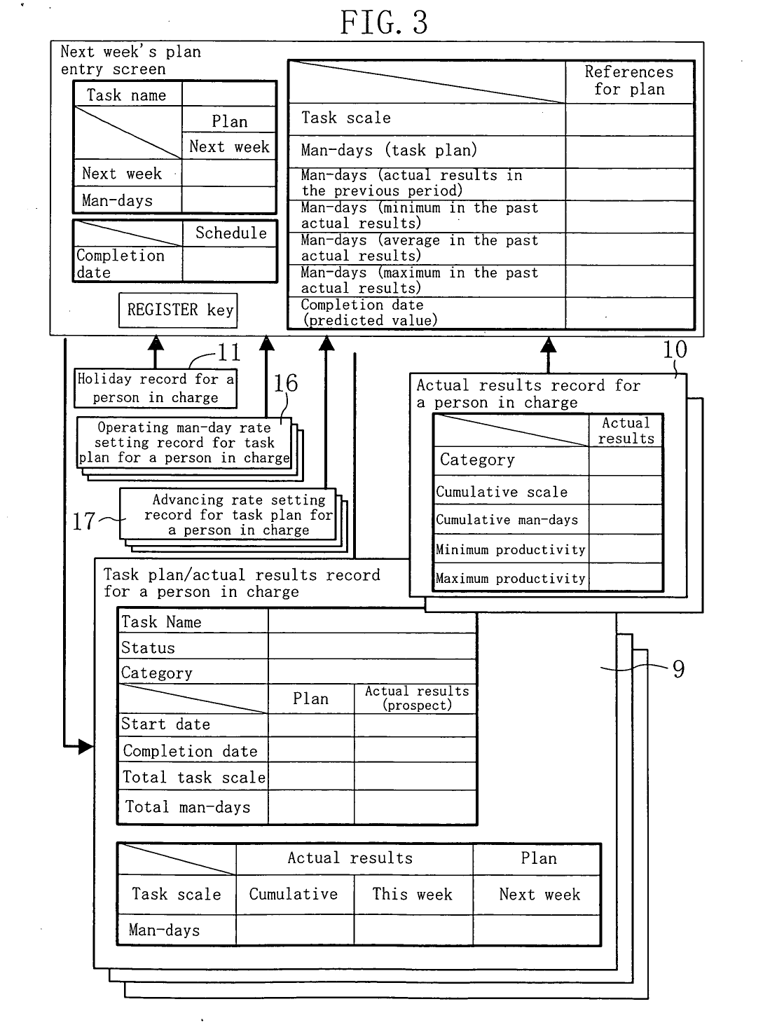

FIG. 2 shows the screen for entry of this week's actual results, and FIG. 3 shows the screen for entry of next week's plan.

In the this week's actual results entry screen shown in the upper portion of FIG. 2, the person in charge enters the actual results in this week (the actual task scale and the actual number of man-days) for each task every weekend, for example. The information items (the status, the start date and the completion date) on the right column of this entry screen are entered according to the situation of each task. For example, if the task has started this week, the status will be “started” and the start date will be entered. If the task has been completed this week, the status will be “completed” and the completion date will be entered. By pressing REGISTER key after all information items have been entered, the entered information is recorded in the task plan/actual results record 9 and the actual results record 10 for the person in charge. After the recording of the actual results in this week, information on the next task plan is called up to the this week's actual results entry screen except for the case that the status is “completed”.

In which positions of the records the entered information items are recorded will be described. The actual results in this week (the actual task scale and the actual number of man-days) are recorded in the “Actual results” column in the lower part of the task plan/actual results record 9 for person in charge shown in FIG. 2. Specifically, once the actual results in this week are recorded in the “This week” column, the actual results in this week are added to the cumulative values up to the last week and the resultant cumulative is values are recorded in the “Cumulative” column. The start date and the completion date entered in the this week's actual results entry screen are recorded in the “Actual results (prospect)” column in the upper part of the task plan/actual results record 9 for the person in charge in FIG. 2, and the information on the status is recorded in the “Status” field in the upper part of this record.

In addition, when any actual results are entered for this week, that is, when an entry other than zero is made for both the task scale and the number of man-days, the control section 7 retrieves a record related to the category to which the task in question belongs from the actual results records 10 for the person in charge shown in FIG. 2, and adds the number of man-days and the task scale to the cumulative values in the “Actual results” column in the table. Also, the control section 7 computes the productivity (the task scale/the number of man-days) of the actual results in this week, and overwrites the productivity in this week in the “Minimum productivity” field if the computed value is less than the minimum, or overwrites the productivity in this week in the “Maximum productivity” field if the computed value exceeds the maximum.

In the next week's plan entry screen shown in FIG. 3, the person in charge enters next week's plan including the planned task scale, the planned number of man-days and the completion date for each task every weekend, for example. As for the “References for plan” (the task scale, five types of the numbers of man-days and the completion date) column on the right side of the next week's plan entry screen, the task progress management device calculates these reference values by referring to the five types of records, that is, the task plan/actual results record 9, the actual results record 10, the holiday record 11, the operating man-day rate setting record 16 for the task plan and the advancing rate setting record 17 for the task plan, for the person in charge, and the calculation results are displayed. The person in charge enters next week's plan by referring to the displayed values. By pressing REGISTER key after all information items have been entered, the entered information is recorded in the task plan/actual results record 9 for the person in charge. After the recording of the information, the information on the next task plan is called up to the this week's actual results entry screen except for the case that the status is “completed”.

In which positions of the record the entered information items are recorded will be described. The next week's plan (the planned task scale and the planned number of man-days) entered on the next week's plan entry screen is recorded in the “Next week” column in the lower part of the task plan/actual results record 9 for the person in charge shown in FIG. 3. The information on the completion date entered on the next week's plan entry screen is recorded in the “Plan” column in the upper part of the task plan/actual results record 9 for the person in charge in FIG. 3.

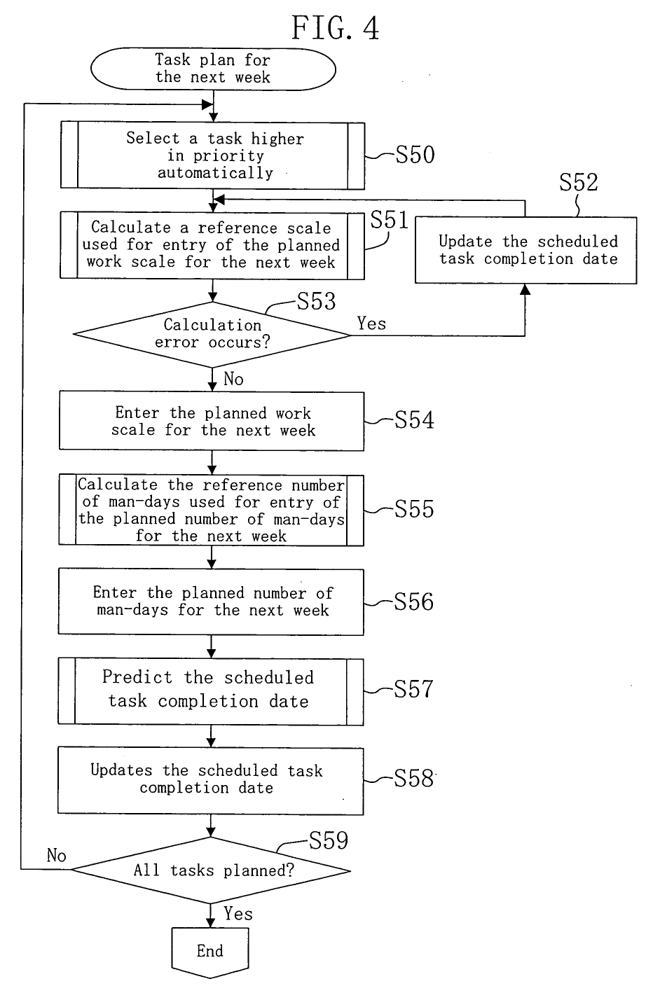

Hereinafter, a procedure of entering next week's plan will be described along with the flowchart in FIG. 4.

FIG. 4 is a flowchart showing a procedure of entering next week's plan in the task progress management method of this embodiment. When the person in charge opens the next week's plan entry screen shown in FIG. 3, the task progress management device executes the flow of process steps shown in FIG. 4.

Referring to FIG. 4, in step S50, a task higher in priority is extracted from the task plan/actual results records 9 for the person in charge. The control section 7 may extract a task, but the extraction can also be made manually by the person in charge.

In step S51, the control section 7 calculates the task scale to be planned for the next week so that the extracted task is completed by the completion date without fail.

In step S53, if an error occurs in the calculation results in the step S51, the person in charge is asked to change the scheduled task completion date in step S52. If no error occurs in the calculation results in the step S51, the calculated task scale is displayed as reference data.

In step S54, the person in charge enters the planned task scale for the next week.

In step S55, the control section 7 calculates five types of the numbers of man-days to be used for the planned number of man-days for the next week, and the results are displayed as reference data.

In step S56, the person in charge enters the planned number of man-days for the next week.

In step S57, the computation section 12 predictively computes the scheduled task completion date, and the display section 2 displays the resultant date as reference data.

In step S58, the person in charge updates the task completion date and press REGISTER key.

In step S59, the person in charge checks whether or not all tasks have been planned. If all tasks have been planned, the person closes the next week's plan entry screen and terminates the next week's planning. If an unplanned task is left, the process returns to the step S50, to repeat the task planning procedure.

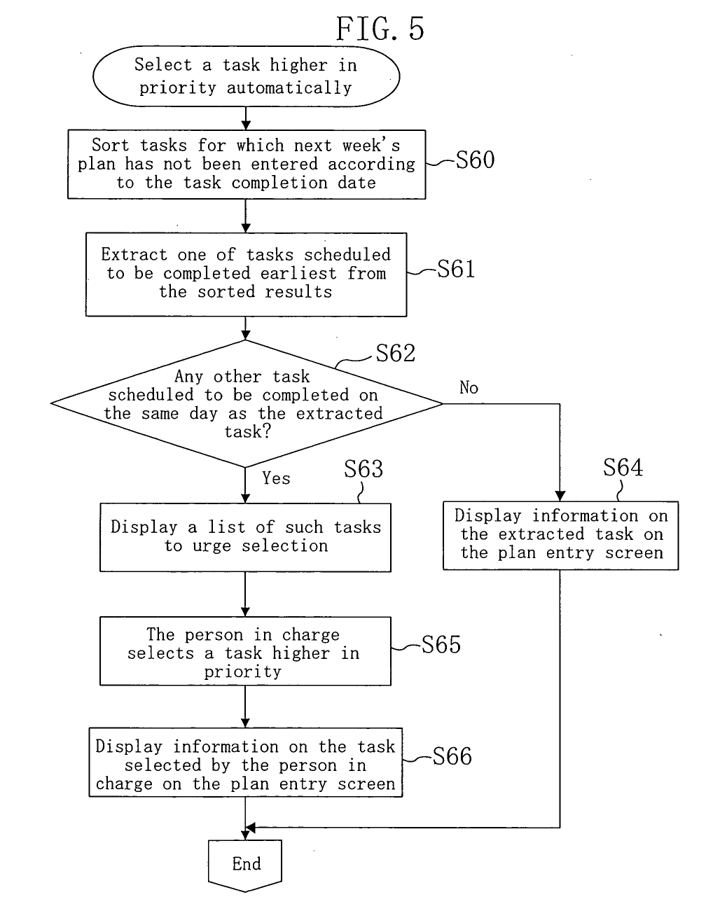

The processing of the step S50 of automatically selecting a task higher in priority described above will be described in detail. FIG. 5 is a flowchart of a procedure of automatically selecting a task higher in priority in the task progress management method of this embodiment.

Referring to FIG. 5, in step S60, the control section 7 extracts all tasks for which the next week's task plan has not been entered, among uncompleted tasks in the task plan/actual results records for the person in charge, in response to a notification from the entry section 1. The control section 7 then sorts the extracted tasks according to the task completion date.

In step S61, the control section 7 extracts the task of which the scheduled task completion date comes earliest.

In step S62, whether or not there exists any other task of which the scheduled task completion date is the same as that of the task extracted in the step S61 is determined. If there exists any, a list of all tasks having the same scheduled completion date is displayed in step S63.

In step S65, the person in charge selects one task in the list.

In step S66, the control section 7 regards the selected task as the one highest in priority, and copies the task name from the task plan/actual results record 9 for the person in charge to the next week's plan entry screen.

If, in the step S62, there exists no task having the same scheduled completion date as the task extracted in the step S61, the process proceeds to step S64 in which information on the task extracted in the step S61 is displayed on the next week's plan entry screen. Thus, the step S50 is terminated.

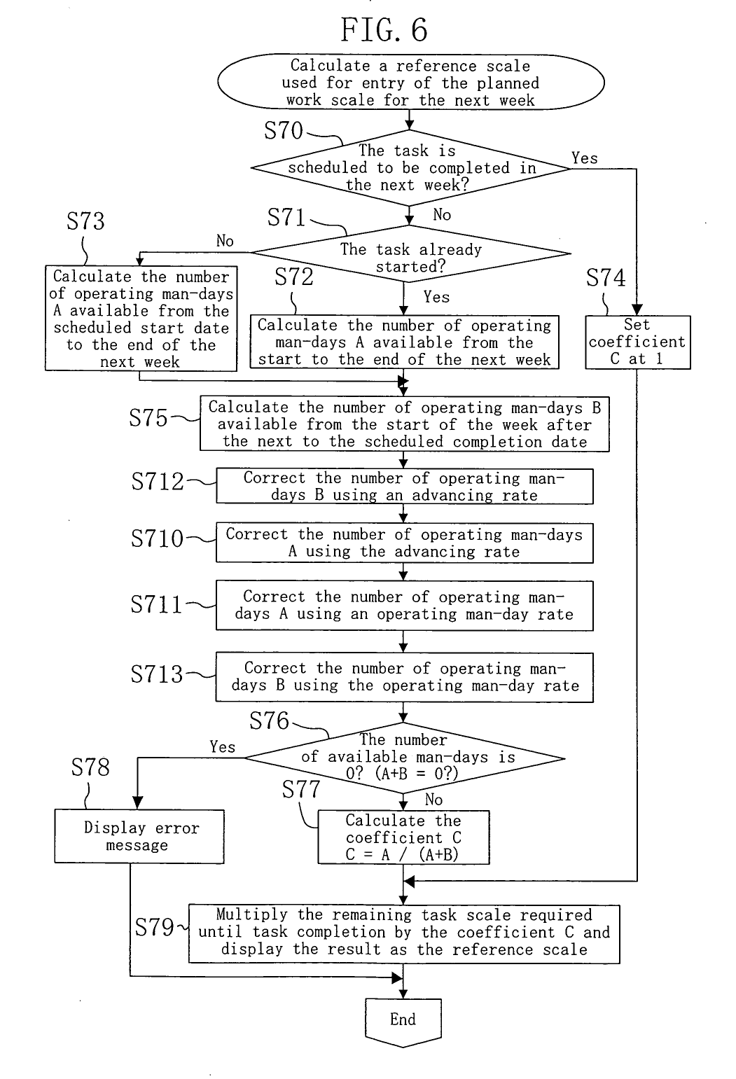

The processing of the step S51 of calculating the task scale to be planned for the next week so that the extracted task is completed by the completion date without fail described above will be described in detail. FIG. 6 is a flowchart of the processing of the step S51 shown in FIG. 4.

In step S70, whether or not the selected task is to be completed by the end of the next week is determined. If the selected task is to be completed by the end of the next week, the coefficient for computation of the planned task scale is set at 1 in step S74. This processing aims to calculate the planned task scale for the next week so that the task, is terminated by the completion date without fail. Therefore, if the task is to be completed by the end of the next week, the task scale calculated in this processing should be equal to the remaining task scale. After the step S74, the process proceeds to step S79 to be described later.

If the selected task is not to be completed by the end of the next week in the step S70, whether or not the task has already started is checked in step S71. The process proceeds to step S72 if the task has been started, or otherwise proceeds to step S73.

In the step S72, the reference man-day computation part 14 of the computation section 12 calculates the number of operating man-days A available from the start to the end of the next week, and the process proceeds to step S75.

If the task has not started, in the step S73, the computation section 12 calculates the number of operating man-days A available from the scheduled task start date to the end of the next week, and the process proceeds to step S75.

In the steps 72 and 73, the correct number of available man-days is calculated in consideration of the holiday record 11 for the person in charge and information on man-days already planned for other tasks. For a task that has not yet started and is scheduled to start after the next week, “0” is displayed as the reference task scale.

In step S75, the number of operating man-days B available from the start of the week after the next to the scheduled task completion date is calculated. In this calculation, also, the correct number of available man-days is provided in consideration of information recorded in the holiday record 11 for the person in charge.

In step S712, the second correction computation part 20 corrects the number of available operating man-days B using the advancing rate set for this task plan. The above correction is performed in the following manner. Assuming that the advancing rate is 20%, for example, the number of man-days equivalent of 20% of the total number of man-days is determined at the planning of this task. The resultant value is stored in the advancing rate setting record 17 for the task plan for the person in charge shown in FIG. 1. In the correction, the stored number of man-days is subtracted from the number of available operating man-days A.

In step S710, the second correction computation part 20 corrects the number of available operating man-days A using the advancing rate set for this task plan.

The above correction is performed in the following manner. As described above, assuming that the advancing rate is 20%, for example, the number of man-days equivalent of 20% of the total number of man-days is determined at the planning of this task. The resultant value is stored in the advancing rate setting record 17 for the task plan for the person in charge shown in FIG. 1. The stored number of man-days is rounded off to two decimal places, for example, for convenience. In the correction, the stored number of man-days is subtracted starting from the number of man-days for the final week of the task plan. As a result of the subtraction, if the last subtracted position is in the next week, the number of available operating man-days A is corrected to the resultant subtracted number of man-days. If the last subtracted position is not in the next week, no correction is made for the number of available operating man-days A. In other words, if the number of man-days to be subtracted in the step S712 is greater than the number of available operating man-days B, the number of man-days left after the subtraction is subtracted from the number of available operating man-days A. If the number of available operating man-days A is equal to or less than 0 after this subtraction, it is determined as 0. Note that the advancing rate is not necessarily set at 20%, but may be any value as long as it is greater than 0% and smaller than 100%.

In step S711, the first correction computation part 19 further corrects the number of available operating man-days A corrected in the step S710 using the operating man-day rate set for this task plan.

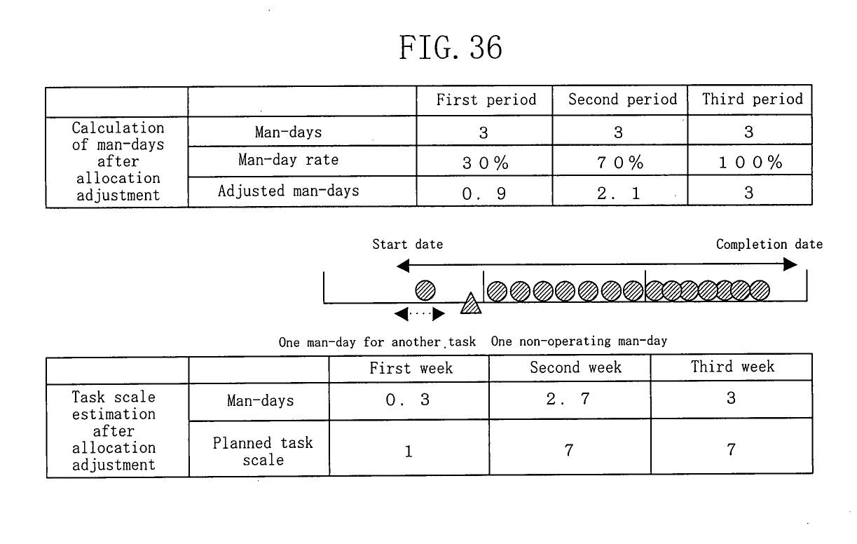

The above correction is performed in the following manner. Assuming that the operating man-day rate pattern shown in FIG. 28 is set at the planning, for example, the available operating man-days from the start date to the completion date are divided into three groups, and the man-days of the respective groups are multiplied by 30%, 70% and 100%, for correction. For example, in the case shown in FIG. 36, the numbers of man-days are 0.9, 2.1 and 3 for the three groups after the correction. These numbers of man-days are allocated to weeks, and the resultant number of man-days for the next week is used as the number of finally available operating man-days A. In the case that the task has already started, the correction in the step S711 is made using the sum of the available operating man-days for the next and subsequent weeks and the actually operated man-days over the duration from the actual start date to the planned completion date, to update the number of operating man-days A. Note that in the above case in which the duration from the start date to the completion date is divided into three, the divided periods do not correspond to the weeks of the task duration.

In step S713, the number of available operating man-days B corrected in the step S712 is further corrected.

The above correction is performed in the following manner. Assuming that the operating man-day rate pattern shown in FIG. 28 is set at the planning, for example, the available man-days from the start date to the completion date are divided into three groups, and the man-days of the respective groups are multiplied by 30%, 70% and 100%, for correction. For example, in the case shown in FIG. 36, the numbers of man-days are 0.9, 2.1 and 3 for the three groups after the correction. These numbers of man-days are allocated to weeks, and the total number of man-days from the week after the next to the week of the completion date is used as the number of finally available operating man-days B. In the case that the task has already started, the correction in the step S713 is made using the sum of the available operating man-days for the next and subsequent weeks and the actually operated man-days over the duration from the actual start date to the planned completion date.

In step S76, whether or not the corrected numbers of available operating man-days A and B obtained in the above calculation are both 0 is determined. If they are both 0, an error message is displayed in step S78, and the process is terminated. The fact that the numbers of available operating man-days A and B are both 0 means that no man-day is available until the task completion date. An error message is therefore displayed to urge the person in charge to adjust the task completion date. In this case, the step S51 shown in FIG. 4 is terminated at this point.

If it is determined in the step S76 that neither of the corrected numbers of available operating man-days A and B obtained by the above calculation is 0 or that either of them is not 0, the coefficient C is computed from expression, C=A/(A+B) in step S77.

In step S79, the remaining task scale required before completion of the task is multiplied by the coefficient C, and the resultant value is displayed as the planned task scale for the next week.

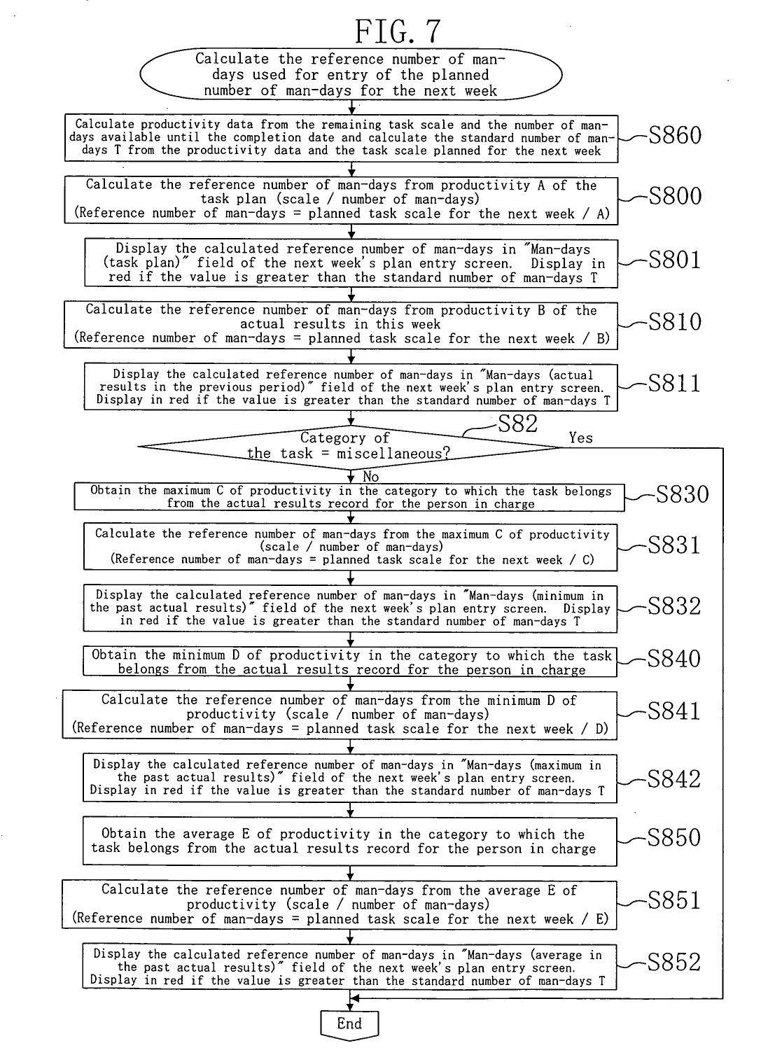

Next, the processing of the step S55 shown in FIG. 4 of computing the reference number of man-days will be described in detail. FIG. 7 is a flowchart of a procedure of the processing of the step S55, in which five types of the numbers of man-days for the planned number of man-days for the next week are calculated and displayed as reference data. Also, the number of man-days is computed from the planned task scale for the next week using the five types of the numbers of man-days.

In step S860, the reference man-day computation part 14 calculates productivity data from the remaining task scale and the number of man-days available until; the completion date, and calculates the standard number of man-days T from the productivity data and the planned task scale for the next week. The standard number of man-days T is used in determination of whether or not an alarm should be made in display of the reference number of man-days.

In step S800, the computation section 12 calculates productivity A from the total task scale and the total number of man-days recorded in the “Plan” column in the task plan/actual results record 9 for the person in charge shown in FIGS. 2 and 3, and calculates the reference number of man-days from the planned task scale for the next week. The productivity A is calculated from expression, (the total task scale)/(the total number of man-days), and the reference number of man-days is calculated from expression, (the planned task scale for the next week)/(productivity A).

In step S801, the calculated value in the step S800 is put in the “Man-days (task plan)” field in the next week's plan entry screen. If the calculated value is greater than the standard number of man-days T, this value is displayed in red as an alarm. This may urge the person in charge to pay attention and hasten completion of the task.

In step S810, the computation section 12 calculates productivity B from the actual task scale and the actual number of man-days in this week recorded in the task plan/actual results record 9 for the person in charge, and then calculates the reference number of man-days from the planned task scale for the next week. The productivity B is calculated from expression, (the actual task scale in this week)/(the actual number of man-days in this week), and the reference number of man-days is calculated from expression, (the planned task scale for the next week)/(productivity B).

In step S811, the calculated value in the step S810 is put in the “Man-days (actual results in the previous period)” field in the next week's plan entry screen. If the calculated result is greater than the standard number of man-days T, this value is displayed in red as an alarm. This may urge the person in charge to pay attention and hasten completion of the task.

In step S82, if the category of the task is “miscellaneous”, no information on the past actual productivity is available, and thus the step S55 is terminated. If the category of the task is other than “miscellaneous”, the maximum C of productivity in the category to which the task in question belongs is determined from the actual results record 10 for the person in charge in step S830. The “maximum C of productivity” refers to the maximum value of task scale processed per man-day, among those of tasks belonging to the same category as the task in question performed by the person in charge, which is calculated from expression, (the maximum of task scale)/(the number of man-days). The maximum C of productivity is found in the actual results record 10 for each category for the person in charge.

In step S831, the reference number of man-days is calculated from the maximum C of productivity and the planned task scale for the next week, which is obtained from expression, (the planned task scale for the next week)/(the maximum C of productivity).

In step S832, the calculated value in the step S831 is put in the “Man-days (minimum in the past actual results)” field in the next week's plan entry screen. If the calculated value is greater than the standard number of man-days T, this value is displayed in red as an alarm. This may urge the person in charge to pay attention and hasten completion of the task. The alarm may be made with display in a color different from the normal color, or with an image that may call attention.

In step S840, the minimum D of productivity in the category to which the task in question belongs is determined from the actual results record 10 for the person in charge at the entry of the actual results of the task. The minimum D of productivity refers to the minimum value among productivity values of tasks belonging to the same category as the task in question performed by the person in charge. The minimum D of productivity is calculated from expression, (the minimum of the task scale)/(number of man-day).

In step S841, the reference man-day computation part 14 computes the reference number of man-days from the minimum D of productivity and the planned task scale for the next week.

In step S842, the calculated value in the step S841 is put in the “Man-days (maximum in the past actual results)” field in the next week's plan entry screen. If the calculated value is greater than the standard number of man-days T, this value is displayed in red as an alarm because task delay may occur. This may urge the person in charge to pay attention and hasten completion of the task.

In step S850, the cumulative task scale and the cumulative number of man-days for tasks belonging to the same category as the task in question are extracted from the actual results record 10 for the person in charge, and the reference man-day computation part 14 calculates the average E of productivity from the extracted values. The average E of productivity is calculated from expression, (the cumulative task scale)/(the cumulative number of man-days).

In step S851, the reference man-day computation part 14 computes the reference number of man-days from the average E of productivity and the planned task scale for the next week, which is calculated from expression, (the planned task scale for the next week)/(the average E of productivity).

In step S852, the calculated value in the step S851 is put in the “Man-days (average in the past actual results)” field in the next week's plan entry screen. If the calculated value is greater than the standard number of man-days T, this value is displayed in red as an alarm. Thus, the calculation of the reference numbers of man-days in the step S55 shown in FIG. 4 is terminated.

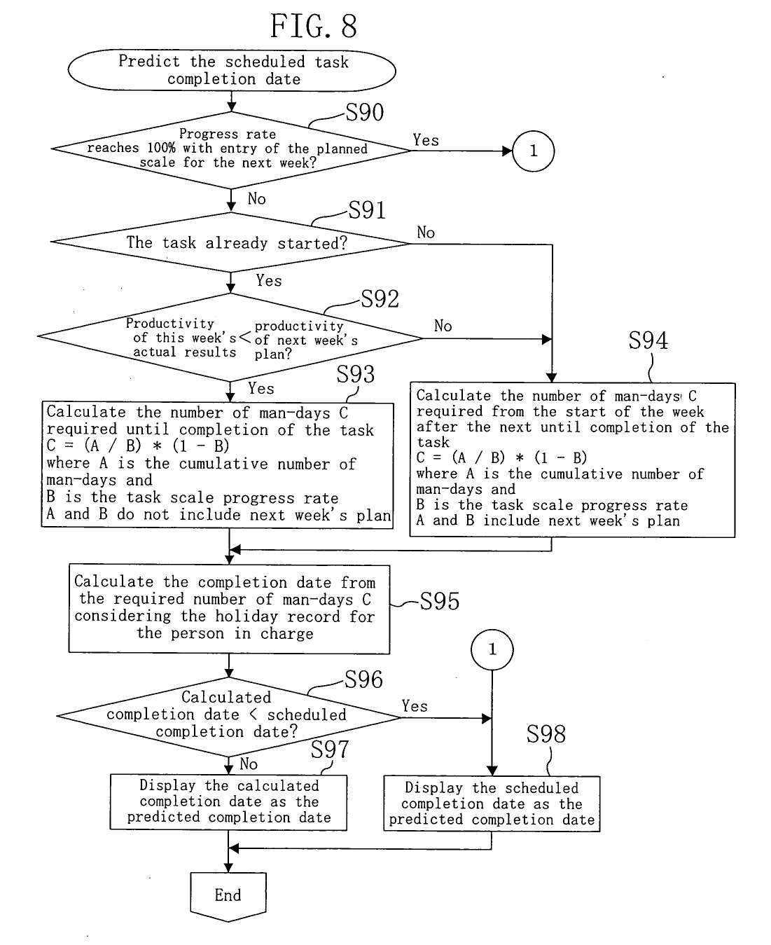

The processing in the step S57 shown in FIG. 4 of predictively calculating the scheduled task completion date will be described in detail. FIG. 8 is a flowchart showing a procedure of the processing of the step S57. The predictive calculation of the task completion date aims to detect a delay of the task. Therefore, basically, if the predicted completion date is earlier than the scheduled completion date recorded in the task plan/actual results record for the person in charge, the scheduled completion date will be returned as the calculation result.

In step S90, whether or not the scale progress rate reaches 100% with the entry of the planned task scale for the next week is determined. If reaching, the process proceeds to step S98, in which the scheduled task completion date recorded in the task plan/actual results record 9 for the person in charge is displayed as the calculation result. If the scale progress does not reach 100% with the entry of the planned task scale for the next week, the process proceeds to step S91.

In the step S91, whether or not the task has already started is determined. The process proceeds to step S92 if the task has started, or proceeds to step S94 if the task has not started.

In the step S92, whether or not the planned productivity for the next week is higher than the actual productivity in this week is determined. The process proceeds to step S93 if the planned productivity for the next week is higher than the actual productivity in this week, or otherwise proceeds to step S94.

In the step S93, the predicted task completion date computation part 15 calculates the number of man-days C required from the start date of the next week to the completion of the task. This calculation is made from expression, C=(A/B)×(1−B) where A is the cumulative number of man-days actually used for the task and B is the task scale progress rate. The values A and B do not include the planned values for the next week. The reason for this is that if productivity data exceeding the actual productivity in this week is used for planning of the task scale and the number of man-days for the next week, the completion schedule may possibly be advanced. More appropriate limit management will therefore be attained by predicting the scheduled completion date adopting the actual results in this week. The process then proceeds to step S95.

If the task has not yet started or if the planned productivity for the next week is lower than the actual productivity in this week, the predicted task completion date computation part 15 calculates the number of man-days C required from the start date of the week after the next to the completion of the task. This calculation is made from expression, C=(A/B)×(1−B) where A is the cumulative number of man-days actually used for the task and B is the task scale progress rate, both including the planned values for the next week. That is, the number of man-days required for one unit of task scale is determined from the cumulative number of man-days A and is then multiplied by the value required to give 100% progress rate, to obtain the number of man-days C. The process then proceeds to step S95.

In the step S95, the predicted task completion date computation part 15 calculates the predicted task completion date from the number of man-days C required to complete the task. In this calculation, an accurate task completion date is predicted using information recorded in the holiday record 11 for the person in charge.

In step S96, the reference man-day comparison computation part 21 determines whether or not the calculated predicted task completion date is earlier than the completion date recorded in the task plan/actual results record 9 for the person in charge. If the calculated completion date is earlier than the scheduled completion date, the process proceeds to the step S98, where the scheduled completion date is displayed as the predicted completion date. Note that in this case the completion date recorded in the task plan/actual results record 9 should be displayed as the task completion date. If the field is “NULL”, however, the completion date in the “Plan” column may be displayed.

If the predicted completion date calculated over the steps S90 to S95 is later than the completion date recorded in the task plan/actual results record 9 for the person in charge, the process proceeds to step S97, in which the completion date calculated in the above steps is displayed as the predicted completion date. Thus, the predictive calculation of the scheduled task completion date is terminated.

By repeating the procedure described above for other tasks, a person who takes charge of a plurality of tasks can manage the progress status of each task.

According to the management method using the task progress management device described above, the progress status of an ongoing task can be grasped, and also the task plan can be made from an objective perspective based on the task scale, the actual results of the person in charge and the like. Hence, scheduled dates can be managed reliably irrespective of the estimation ability of the person in charge.

The task progress management device of this embodiment automatically selects a task higher in priority according to the scheduled completion date in the step S50 shown in FIG. 4. Hence, the problems such as wrong prioritization and occurrence of an omission in a task plan are prevented even when one person takes charge of a plurality of tasks, and thus adherence to the task completion date is ensured.

By using the advancing rate in the calculation of the reference task scale in the step S51 in FIG. 4, an allowance for reviewing a task after the task is roughly finished can be secured. Also, by correcting the number of operating man-days using the operating man-day rate, factors such as the degree of experience of the person in charge in the task can be given in the task plan. Hence, a task plan more precise than conventional ones can be made.

The task progress management device of this embodiment computes a plurality of types (for example, five types) of reference numbers of man-days based on the past task information and the actual results obtained so far. Hence, the planned number of man-days can be estimated more precisely.

Work progress management can be made also for a project shared by a plurality of persons by entering actual results and the like of the plurality of persons in the task progress management device of this embodiment.

### Specific Examples of the Embodiment

In the task progress management method of this embodiment, the effect of the function of calculating the task scale planned for the next week will be described by way of specific example.

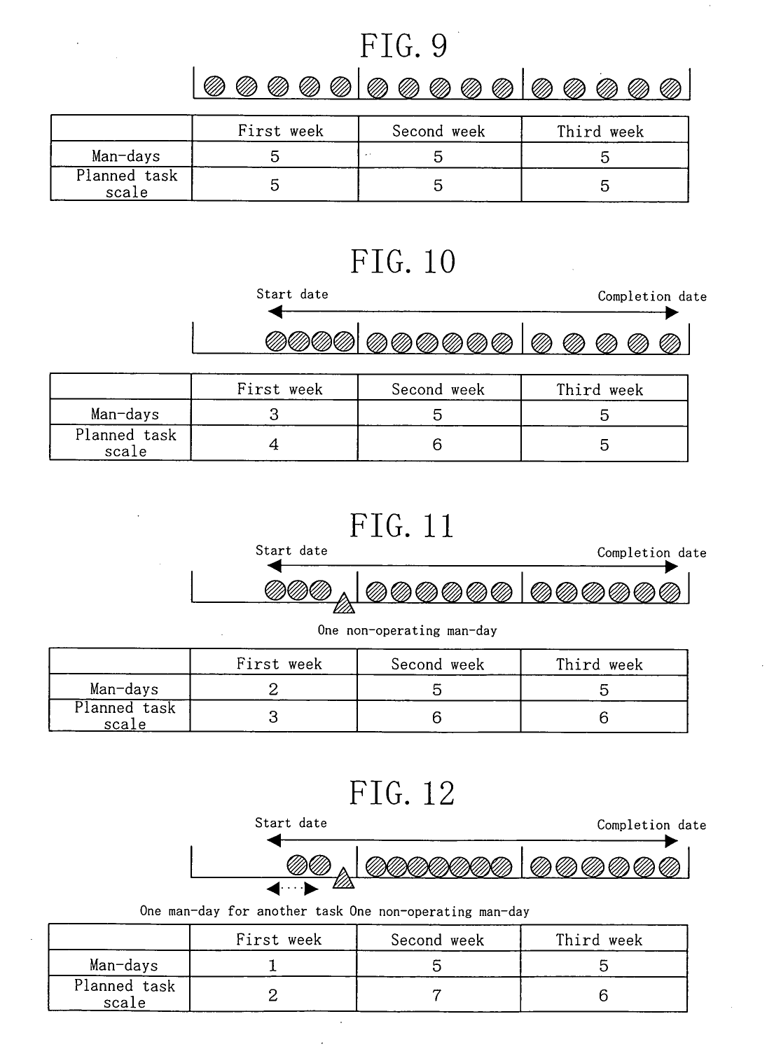

FIGS. 9 to 12 are views for demonstrating a method for calculating the task scale for the next week in Specific Example 1 of the task progress management method of the embodiment of the present invention. In this specific example, it is assumed that the task plan is for executing a task scale of “15” in three weeks and the maximum number of man-days for each week is 5.

In the example shown in FIG. 9, in which the task of the task scale of “15” is to be executed in 15 man-days, the planned task scale per week is 5.

The start date and the completion date are then set for the task plan. In the example shown in FIG. 10, the start date is set at the third day of the first week, and the completion date is set at the fifth day of the third week. By this setting, the number of man-days for each week is changed from that in FIGS. 9 to 3, 5 and 5 for the first, second and third weeks, respectively. In this case, the task scale of “15” is to be executed in 13 man-days, and the planned task scale for the first week is about 4.

Information on a man-day unavailable for the task because the man-day is allocated to a job other than the project or it is a holiday is then acquired from the holiday record 11 (see FIG. 1) for the person in charge, and is put in the task plan.

In the example shown in FIG. 11, assume that one non-operating man-day is set somewhere between the third day and the fifth day of the first week. The number of man-days for the first week is therefore changed from the value in FIG. 10 to 2. In this case, the task scale of “15” is to be executed in 12 man-days, and thus the planned task scale for the first week is about 3.

Information on weekly plans for other tasks is then acquired to improve the precision of the number of man-days available from the start date of the first week. In the example shown in FIG. 12, assume that one man-day is set in a weekly plan for another task somewhere between the start date and the fifth day of the first week. The number of man-days for the first week is therefore changed from the value in FIG. 11 to 1. In this case, the task scale of “15” is to be executed in 11 man-days, and thus the planned task scale for the first week is about 2. That is to say, by adding the start date and the completion date, information on a non-operating man-day and information on a weekly plan for another task to the task plan, the task scale to be planned for the first week is changed from 5 to 2. In this way, the estimation precision of the task scale improves.

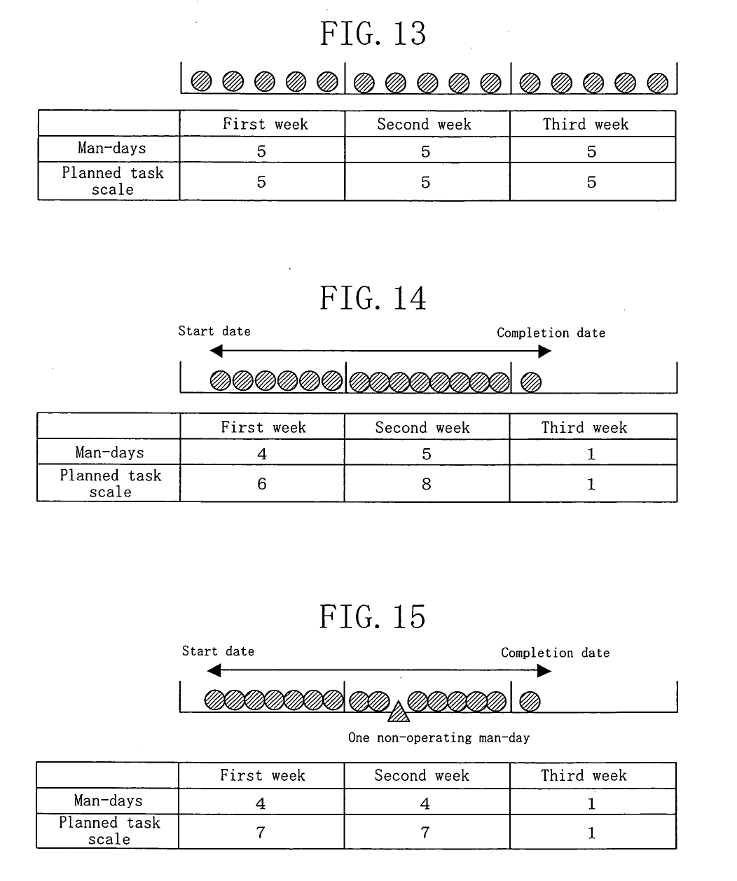

FIGS. 13 to 15 are views for demonstrating a method for computing the task scale for the next week in Specific Example 2 of the task progress management method of the embodiment of the present invention. In this specific example, it is assumed that the task plan is for executing a task scale of “15” in three weeks and the maximum number of man-days for each week is 5.

In the example shown in FIG. 13, in which the task of the task scale of “15” is to be executed in 15 man-days, the planned task scale per week is 5.

The start date and the completion date are then set for the task plan. In the example shown in FIG. 14, the start date is set at the second day of the first week, and; the completion date is set at the first day of the third week. By this setting, the number of man-days for each week is changed from that in FIG. 13 to 4, 5 and 1 for the first, second and third weeks, respectively. Therefore, the task scale of “15” is to be executed in 10 man-days, and thus the planned task scale for the first week is about 6.

Information on a man-day unavailable for the task because the man-day is allocated to a job other than the project or it is a holiday is acquired from the holiday record 11 for the person in charge, and is put in the task plan.

In the example shown in FIG. 15, assume that one non-operating man-day is set in the second week. The number of man-days for the second week is therefore changed from the value in FIG. 13 to 4. In this case, the task scale of “15” is to be executed in 9 man-days, and thus the planned task scale for the first week is about 7. That is to say, by adding the start date and the completion date and information on a non-operating man-day, the task scale to be planned for the first week is changed from 5 to 7. In this way, the estimation precision of the task scale improves.

Next, the effect of the correction computation part using the operating man-day rate setting record will be described in Specific Examples 3 to 5.

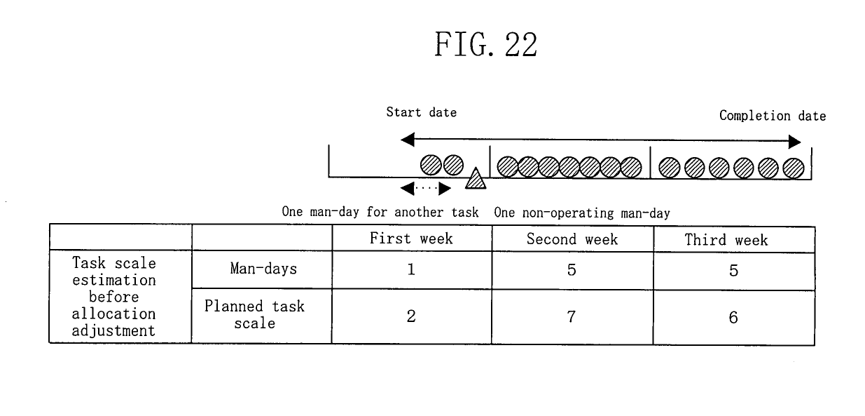

FIGS. 22 to 27 are views for demonstrating the effect of correction using the operating man-day rate in the task progress management method of this embodiment, and FIGS. 28 to 33 are views showing examples of operating man-day rate patterns.

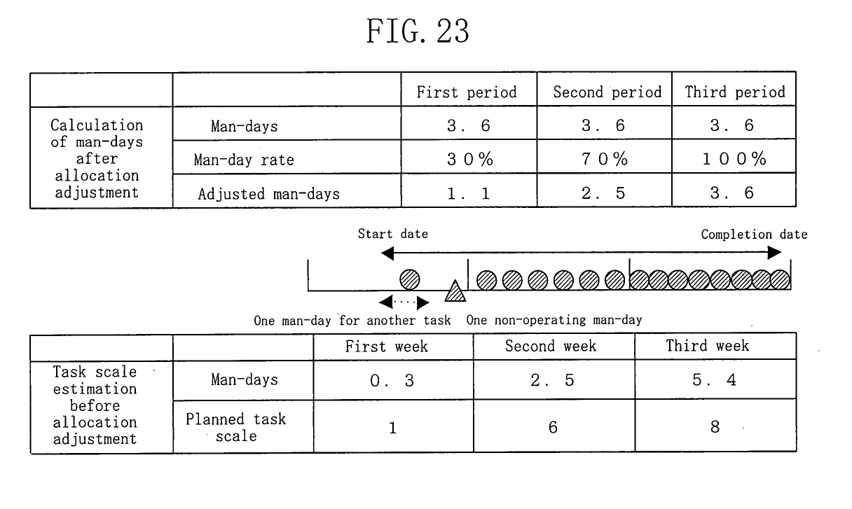

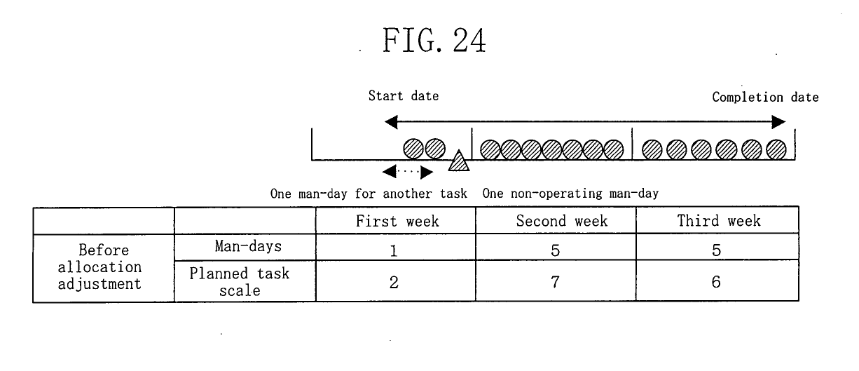

In Specific Example 3, as shown in FIG. 22, it is assumed that the planned task scale for each week is estimated as 2, 7 and 6 for the first, second and third weeks, respectively, when no correction is made. When the operating man-day rate pattern of FIG. 28 is set for this example, the number of man-days is changed to 0.3, 2.5 and 5.4 for the first, second and third weeks, respectively, by the allocation adjustment as shown in FIG. 23, and the planned task scale for each week is corrected to 1, 6 and 8 for the first, second and third weeks, respectively.

The specific calculation for the above is as follows. In the above example, the total number of operating man-days is 1+5+5=11. When the three-division allocation pattern is applied to these man-days, the number of man-days for each period is 11/3=3.6 man-days. The man-days for the respective periods are then adjusted with the operating man-day rate of 30%, 70% and 100%, to obtain the adjusted number of operating man-days of 1.1, 2.5 and 3.6, respectively. The adjustment results are allocated to the weeks. Specifically, the adjusted number of man-days for the first week is 1.1×(3.6−1)/3.6≈0.3, the adjusted number of man-days for the second week is {1.1×(3.6−1)/3.6}+[2.5×{5−(3.6−1)}/3.6]≈2.5, and the adjusted number of man-days for the third week is 2.5×[5−{5−(3.6−1)}]/3.6+3.6≈5.4.

The corrected task scale estimation will be determined appropriate in the case that the person in charge is not accustomed to the task and is expected to be able to do the task at a higher pitch in the latter period.

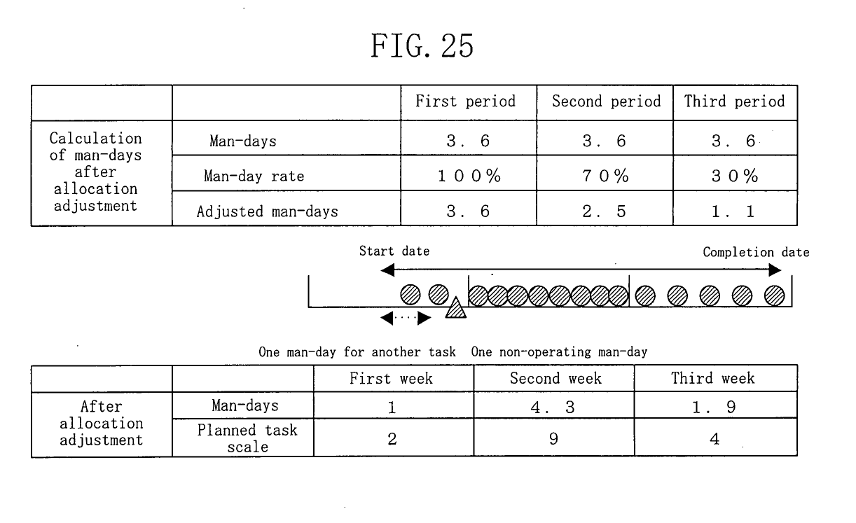

In Specific Example 4 shown in FIG. 24, it is assumed that the planned task scale for each week is estimated as 2, 7 and 6 for the first, second and third weeks, respectively, when no correction is made. When the operating man-day rate pattern of FIG. 29 is set for this example, the planned task scale for each week is corrected to 2, 9 and 4 for the first, second and third weeks, respectively, as shown in FIG. 25. The corrected task scale estimation will be determined appropriate in the case that a difficulty is expected to occur in the latter period.

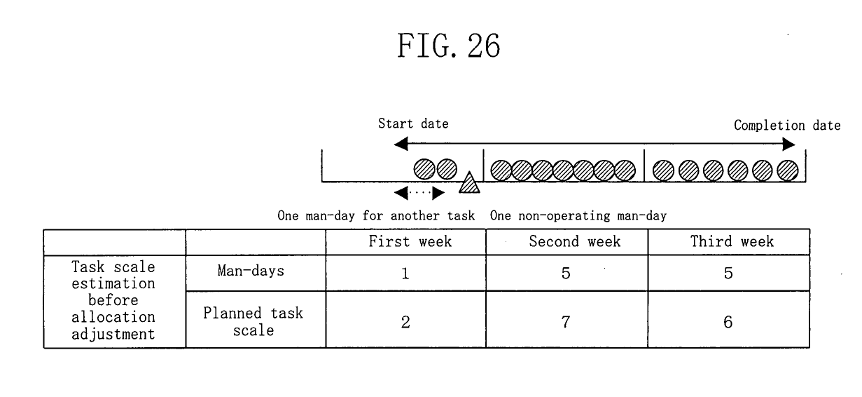

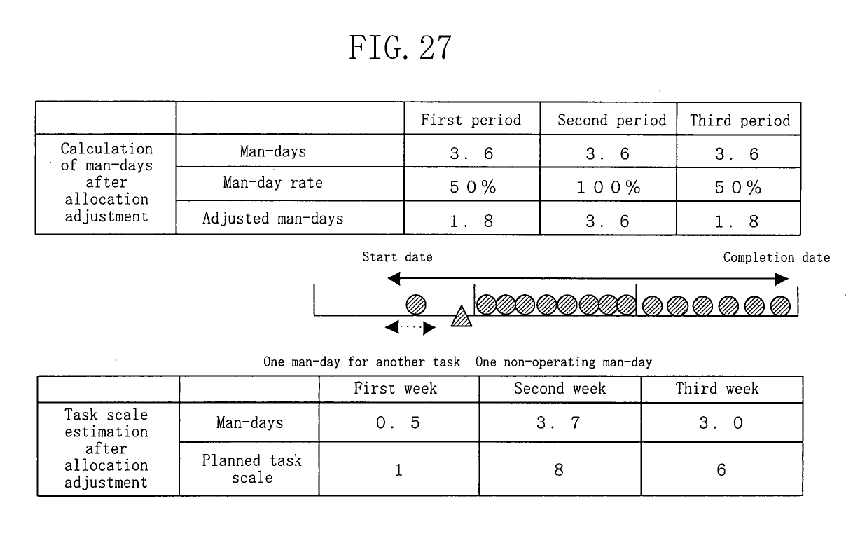

In Specific Example 5 shown in FIG. 26, it is assumed that the planned task scale for each week is estimated as 2, 7 and 6 for the first, second and third weeks, respectively, when no correction is made. When the operating man-day rate pattern of FIG. 30 is set for this example, the planned task scale for each week is corrected to 1, 8 and 6 for the first, second and third weeks, respectively, as shown in FIG. 27. The corrected task scale estimation will be determined appropriate in the case that the person in charge is not accustomed to this task and a problem is expected to occur in review of the results after completion.

As described above, although the pre-corrected estimation information is the same for the above three examples shown in FIGS. 22, 24 and 26, by setting a man-day rate considering the nature of the task and the skill of the person in charge for the task to correct the task scale estimated value, situation-considered accurate task scale estimation is attained. Also, by setting in advance a plurality of operating man-day rate patterns as shown in FIGS. 28 to 33, efficient entry of a task plan is attained.

Next, the effect of the second correction computation part 20 using the advancing rate setting record 17 will be described.

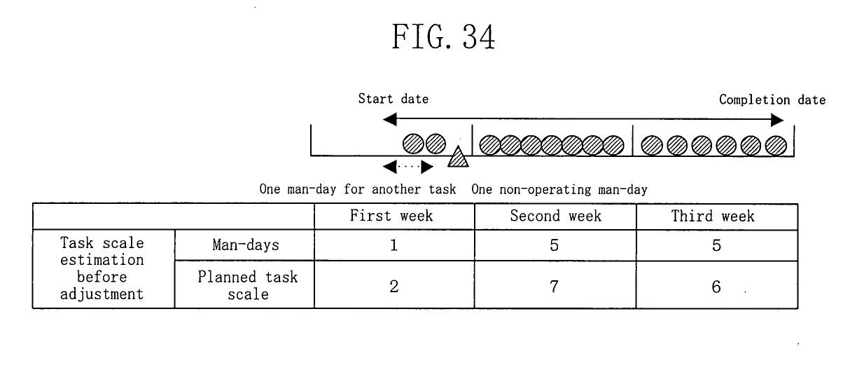

FIGS. 34 to 37 are views for demonstrating the effect of correction using the advancing rate in the task progress management method of this embodiment.

In Specific Example 6 shown in FIG. 34, it is assumed that the planned task scale for each week is estimated as 2, 7 and 6 for the first, second and third weeks, respectively, when no correction is made.

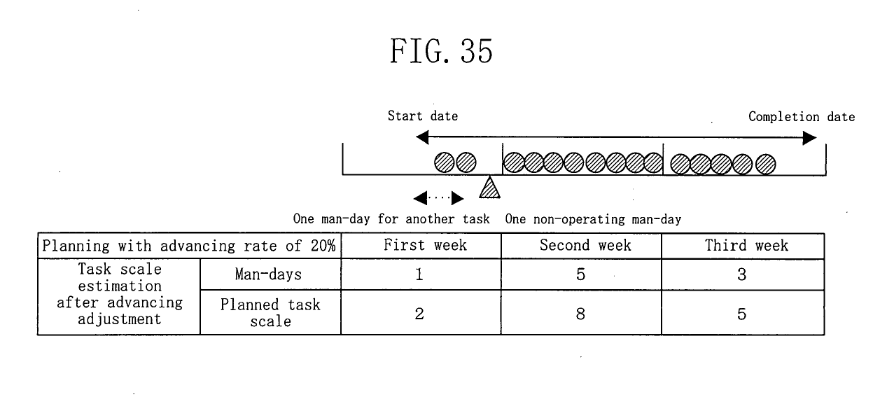

When an advancing rate of 20%, for example, is set for this example, the planned task scale for each week is corrected to 2, 8 and 5 for the first, second and third weeks, respectively, as shown in FIG. 35. When the operating man-day rate pattern of FIG. 28 is further set for the resultant values, the planned task scale for each week is corrected to 1, 7 and 7 for the first, second and third weeks, respectively, as shown in FIG. 36.

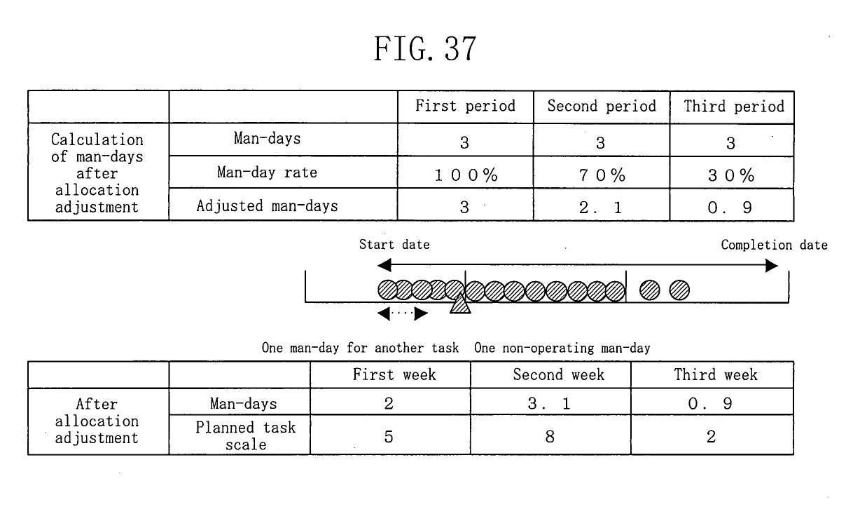

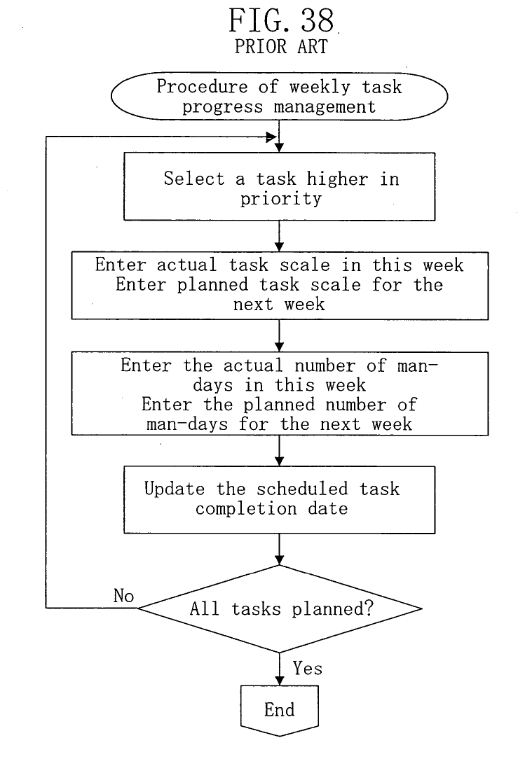

Alternatively, when the operating man-day rate pattern of FIG. 29 is set for the results of the correction with the advancing rate of 20%, the planned task scale for each week is corrected to 5, 8 and 2 for the first, second and third weeks, respectively, as shown in FIG. 37.

As described above, the task can be completed in advance by setting the advancing rate. With such an advancing rate, even in the event that a problem is found in the task results, a task delay behind the planned completion date can be prevented. When both the advancing rate and the operating man-day rate are set, the estimated value largely differs between before and after the correction. For example, while the task scale for the first week is 2 before the correction in the example shown in FIG. 34, it is 1 after the correction in the example shown in FIG. 36. The task scale for the first week is even 5 after the correction in the example shown in FIG. 37, which is greatly different from the task scale before the correction. In this way, an accurate task scale can be obtained by adopting the estimation method considering the nature of the task and the skill of the person in charge for the task.

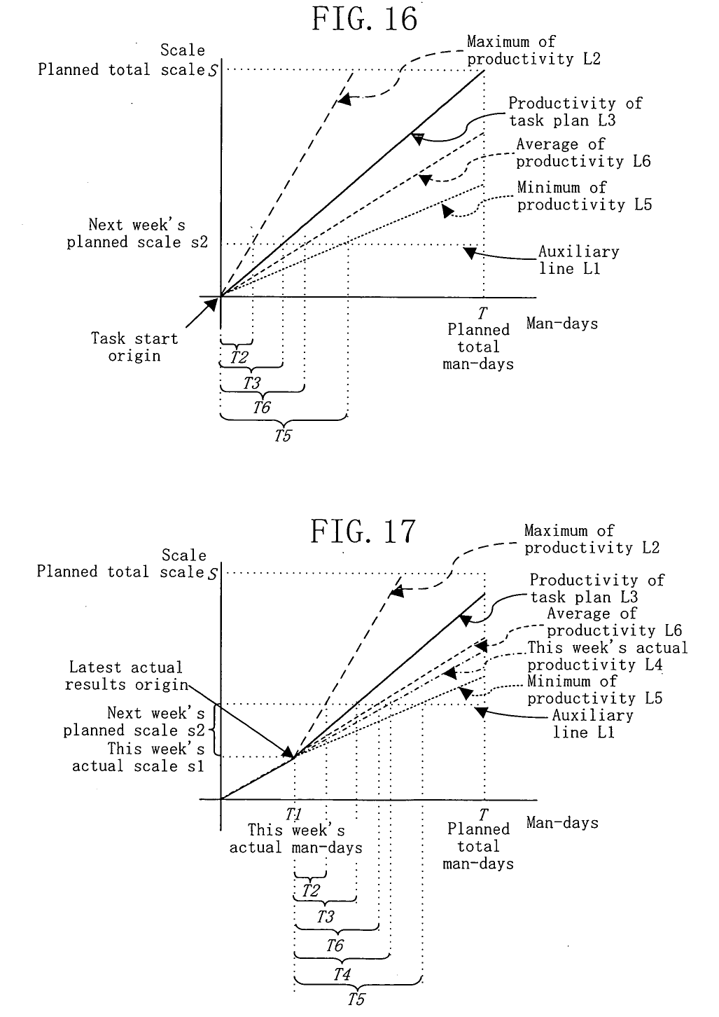

Hereinafter, the function of computing five types of numbers of man-days required for planning of the task scale for the next week will be described. FIGS. 16 and 17 are graphs for demonstrating a method for calculating the number of man-days for the next week. The x-axis and y-axis of these graphs represent the number of man-days and the scale, respectively.

FIG. 16 shows an example in which the task will start next week (the task has not yet started). In this graph, a line L1 represents an auxiliary line extending horizontally from the position of a planned scale s2 for the next week, and lines L2 L3, L5 and L6 represent the gradients of productivity from the task start origin as the starting point. Specifically, the line L2 represents the maximum of productivity, the line L3 represents the productivity of the task plan, the line L5 represents the minimum of productivity, and the line L6 represents the average of productivity. The numbers of man-days are calculated from the intersection points between the auxiliary line L1 and the four productivity lines L2 L3, L5 and L6.

First, the number of man-days T3 can be calculated from the line L3 of the productivity of the task plan. The productivity of the task plan is obtained from the planned total number of man-days T and the planned total task scale S. The maximum, minimum and average of past productivity values in the category to which the task in question belongs are then acquired from the actual results record for the person in charge. The numbers of man-days T2, T5 and T6 can be calculated from the lines L2, L5 and L6 of the maximum, minimum and average of productivity, respectively. T2 is smallest and T5 is largest among the four calculated numbers of man-days. The person in charge refers to these four pieces of information to improve the estimation precision of the number of man-days.

FIG. 17 shows an example in which the reference number of man-days for the next week is derived from the planned scale for the second week. In this case, the numbers of man-days are calculated from the intersection points between the auxiliary line L1 extending horizontally from the position of the planned scale s2 for the next week added to an actual scale s1 in this week and five lines L2, L3, L4, L5 and L6 representing the gradients of productivity from the latest actual results origin as the starting point.

The number of man-days T3 can be calculated from the line L3 of the productivity of the task plan. The productivity of the task plan is obtained from the planned total number of man-days T and the planned total task scale S. The number of man-days T4 can be calculated from the line L4 of the actual productivity in this week (latest actual productivity). The actual productivity in this week is determined from the actual number of man-days T1 in this week and the actual scale s1 in this week. The numbers of man-days T2, T5 and T6 can be calculated from the lines L2, L5 and L6 of the maximum, minimum and average of productivity, respectively. In this method, since the number of man-days based on the actual information in the latest week is calculated as reference, the estimation precision of the number of man-days can be more improved than in the example shown in FIG. 16.

Next, the effect of the function of calculating five types of numbers of man-days required for planning the task scale for the next week will be described in two examples to follow.

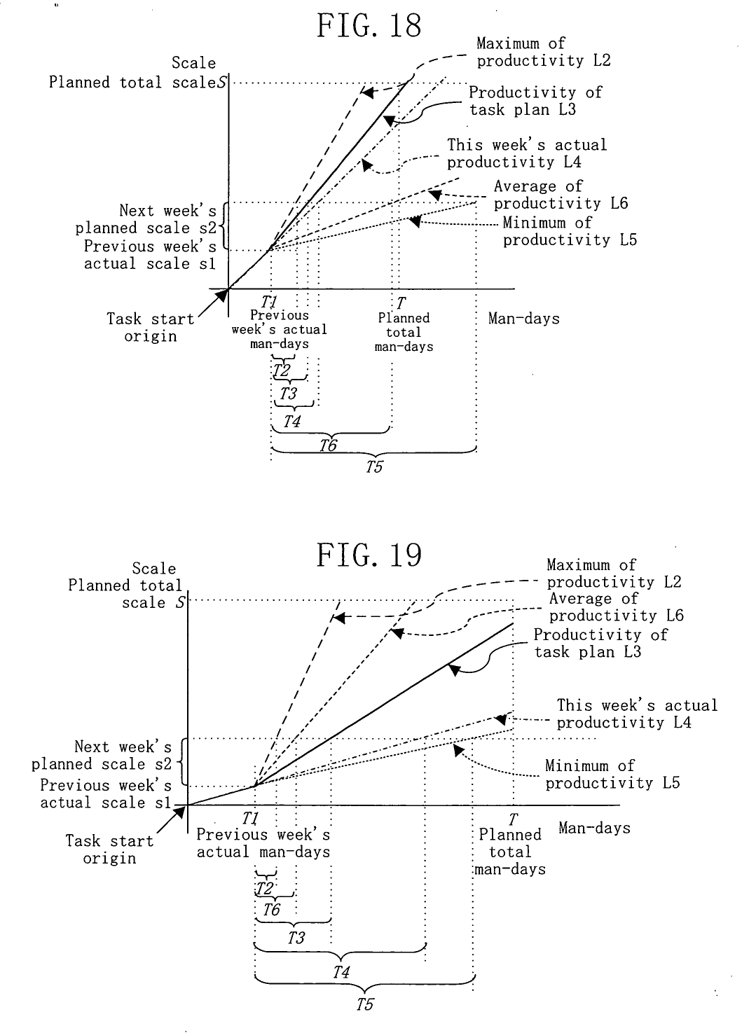

FIGS. 18 and 19 are graphs for demonstrating a method for calculating the number of man-days for the next week.

FIG. 18 shows an example in which the productivity of the task plan (L3) and the actual productivity in this week (L4) are roughly proximate to the maximum of productivity (L2), and are largely apart from the average of productivity (L6) and the minimum of productivity (L5). In other words, the three types of numbers of man-days, that is, the number of man-days T2 calculated from the line L2 of the maximum of productivity, the number of man-days T3 calculated from the line L3 of the productivity of the task plan, and the number of man-days T4 calculated from the line L4 of the actual productivity in this week, are values close to one another but are largely different from the number of man-days T6 calculated from the line L6 of the average of productivity and the number of man-days T5 calculated from the line L5 of the minimum of productivity. In this case, supposing the productivity for the next week does not differ largely from that in this week, the estimation precision will improve by determining the estimated number of man-days for the next week by referring to the number of man-days T3 or T4. In reverse, supposing the task has a problem to be solved in the next week too risky to estimate the number of man-days for the next week using the actual productivity in this week (L4), it will be more appropriate and more precise to estimate the number of man-days for the next week by referring to the number of man-days T6 or T5. In the conventional estimation, the person in charge estimated with his or her sense by referring to the number of man-days T3 calculated from the productivity of the task plan (L3) and the number of man-days T4 calculated from the actual productivity in this week (L4), and this caused a problem in estimation precision. In the task progress management method of this embodiment, in which the productivity information of the past cumulative actual results is used, the estimation precision can be greatly improved, and thus the conventional problems can be solved.

FIG. 19 shows an example in which the actual productivity in this week (L4) is roughly proximate to the minimum of productivity (L5), and is largely apart from the average of productivity (L6), the productivity of the task plan (L3) and the maximum of productivity (L2). In other words, the number of man-days T4 calculated from the line L4 of the actual productivity in this week is close to the number of man-days T5 calculated from the line L5 of the minimum of productivity, and is largely different from the other types of the numbers of man-days. This case implies that this week failed to yield results as planned. The following causes are considered for this failure of yielding results as planned, for example. That is, the estimation at the planning of the task may have been wrong, or a type of work to which the person in charge was unaccustomed was done at the start of the task and this may have delayed the task. In the case that the estimation at the planning of the task was wrong, the actual productivity in this week (L4) can be used as a more reliable figure. Hence, it is appropriate and provides high estimation precision to refer to the number of man-days T4 in estimation of the number of man-days for the next week. In the case that a type of work to which the person in charge was unaccustomed was done at the start of the task and this delayed the task, the person in charge may judge that this problem will no more matter next week. If so, the productivity of the task plan (L3), rather than the actual productivity in this week (L4), can be used as an appropriate figure. Hence, it is appropriate and provides high estimation precision to refer to the number of man-days T3 in estimation of the number of man-days for the next week.

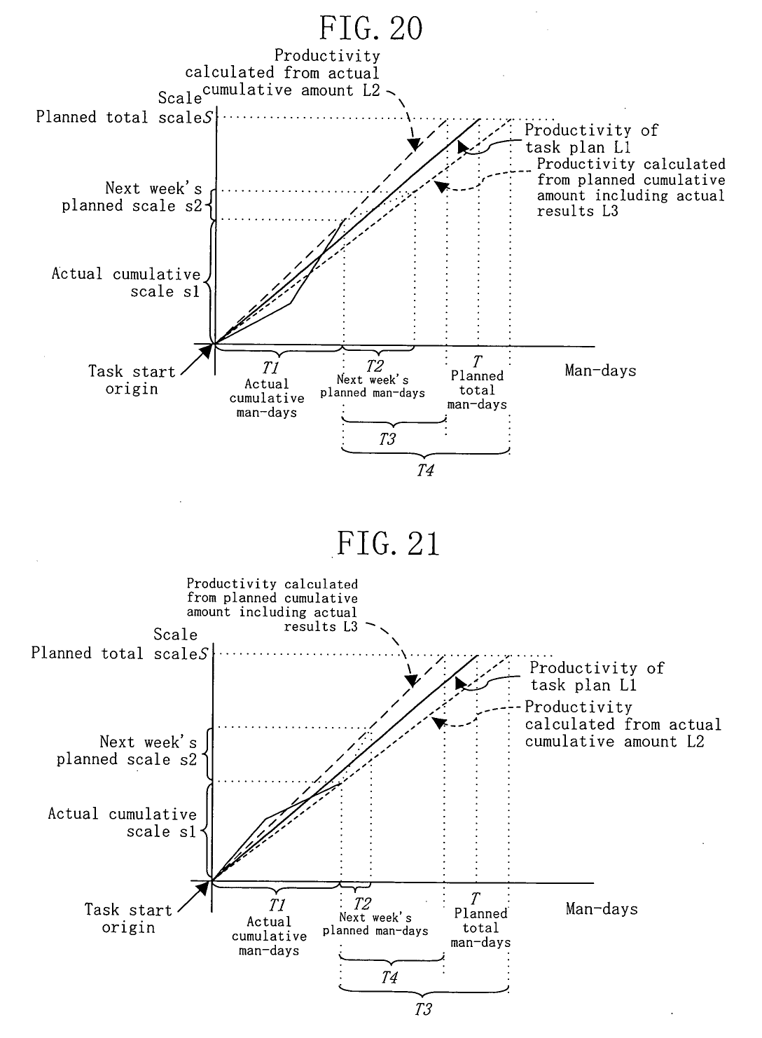

FIGS. 20 and 21 are graphs for demonstrating a method for calculating a predicted task completion date in the task progress management method of this embodiment.

FIG. 20 shows an example in which the scale and the number of man-days for the next week are planned with a productivity value lower than the actual productivity in this week. In this case, the productivity (L2) determined from the actual cumulative amount is greater than the productivity (L3) determined from the planned cumulative amount. The value of L3 is obtained using the sum of an actual cumulative scale s1 and a planned scale s2 for the next week and the sum of the actual cumulative number of man-days T1 and the planned number of man-days T2 for the next week. This case implies that the plan for the next week is slower than the actual results in this week. Therefore, in calculation of the number of man-days required until completion of this task, it is judged appropriate to use the number of man-days T4 calculated from the productivity L3 determined from the planned cumulative amount, not the number of man-days T3 calculated from the productivity L2 determined from the actual cumulative amount.

FIG. 21 shows an example in which the scale and the number of man-days for the next week are planned with a productivity value higher than the actual productivity in this week. In this case, the productivity (L2) determined from the actual cumulative amount is smaller than the productivity (L3) determined from the planned cumulative amount. The value of L3 is obtained using the sum of the actual cumulative scale s1 and the planned scale s2 for the next week and the sum of the actual cumulative number of man-days Ti and the planned number of man-days T2 for the next week. This case implies that the plan for the next week is higher in productivity than the actual results in this week, and thus it may be risky to attain the plan for the next week. Therefore, in calculation of the number of man-days required until completion of this task, it is judged appropriate to use the number of man-days T3 calculated from the productivity L2 determined from the actual cumulative amount, not the number of man-days T4 calculated from the productivity L3 determined from the planned cumulative amount.

As described above, the task progress management device and the task progress management method using the same according to the present invention are useful in execution of a project with one person or a plurality of persons.

While the present invention has been described in a preferred embodiment, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

1. A task progress management device for managing the progress status of a selected task, comprising:
an entry section for entering a task plan and task actual results of an individual;
a storage section for storing the task plan, the task actual results and non-operating man-day information including holiday information;
a computation section including: a reference man-day computation part for computing the number of man-days available in a first period starting from termination of the entry of information in the entry section and the number of man-days available in a second period after the passing of the first period until a completion date of the selected task, based on at least the task plan, the task actual results and the non-operating man-day information; and a reference task scale computation part for estimating a reference task scale in the first period from a rate of the number of man-days available in the first period to the number of man-days available in the second period and the remaining task scale required until completion of the task;
a display section for displaying the information entered in the entry section and the computation results in the computation section; and
a control section for executing write of information to the storage section, read of information from the storage section and transfer of the computation results in the computation section to the display section.

2. The device of claim 1, wherein the task plan includes a task start date, a task completion date and a total task scale,
in the case of setting an operating man-day rate for weighting the number of operating man-days in each of periods into which the duration from the task start date to the task completion date is divided arbitrarily, the storage section includes an operating man-day rate pattern record in which at least one pattern of the operating man-day rate is written, and
the computation section further includes a first correction computation part for correcting the numbers of man-days available in the first and second periods using the pattern of the operating man-day rate.

3. The device of claim 1, wherein the task plan includes a task start date, a task completion date, the total number of man-days and a total task scale,
the storage section includes an advancing rate setting record in which the result of multiplication of the total number of man-days by an arbitrarily set advancing rate is written, and
the computation section further includes a second correction computation part for correcting the numbers of man-days available in the first and second periods using the result of the multiplication.

4. The device of claim 1, wherein there are a plurality of tasks of which the progress statuses are managed, and
in the case that each task plan includes a task completion date, the plurality of tasks are selected in the order of the task completion date, the earliest date first.

5. A task progress management device for managing the progress status of a selected task, comprising:
an entry section for entering a task plan and task actual results of an individual, the task plan including a task category, a task start date, a task completion date, a total task scale and the total number of man-days of the selected task, the task actual results including a task scale and the number of man-days completed every fixed period;
a storage section for storing the task plan and the task actual results, as well as productivity of the task plan calculated from (the total task scale)/(the total number of man-days), and a cumulative task scale and the cumulative number of man-days accumulated for each task category;
a computation section including a reference man-day computation part for computing the maximum and minimum of productivity from the task scale and the number of man-days completed in each of fixed periods, computing the productivity of the task plan from the total task scale and the total number of man-days, computing the average of productivity from the cumulative task scale and the cumulative number of man-days, and computing latest actual productivity from the task scale and the number of man-days completed in the latest one of the fixed periods, the computation section also computing the number of man-days for the next fixed period using the maximum and minimum of productivity, the average of productivity, the productivity of the task plan and the latest actual productivity;
a display section for displaying the information entered in the entry section and the computation results in the computation section; and
a control section for executing write of information to the storage section, read of information from the storage section, and transfer of the computation results in the computation section to the display section.

6. The device of claim 5, wherein the computation section computes productivity data from the remaining task scale of the selected task and the number of man-days available until the completion date, and computes the standard number of man-days from the productivity data and the planned task scale for the next fixed period, and
the display section gives warning display different from normal display if any of the first reference number of man-days determined from the productivity of the task plan and the planned task scale for the next fixed period, the second reference number of man-days determined from the latest actual productivity and the planned task scale for the next fixed period, the third reference number of man-days determined from the maximum of productivity and the planned task scale for the next fixed period, the fourth reference number of man-days determined from the minimum of productivity and the planned task scale for the next fixed period, and the fifth reference number of man-days determined from the average of productivity and the planned task scale for the next fixed period is greater than the standard number of man-days.

7. A task progress management device for managing the progress status of a selected task, comprising:
an entry section for entering a task plan and task actual results of an individual, the task plan including a total task scale and the total number of man-days of the selected task, the task actual results including a task scale and the number of man-days completed every fixed period;
a storage section for storing the task plan and the task actual results, as well as the cumulative number of man-days and a cumulative task scale of the selected task, and a task scale progress rate determined from the cumulative task scale and the total task scale;
a computation section including a predicted task completion date computation part for calculating the number of man-days required until completion of the selected task from the cumulative number of man-days of the task and the task scale progress rate and predicting a scheduled completion date of the task based on the calculation result;
a display section for displaying the information entered in the entry section and the computation results in the computation section; and
a control section for executing write of information to the storage section, read of information from the storage section, and transfer of the computation results in the computation section to the display section.

8. The device of claim 7, wherein the computation section computes an estimated task scale, the estimated number of man-days and estimated productivity for the next fixed period, and computes latest actual productivity from the task scale and the number of man-days in the latest fixed period, and
the predicted task completion date computation part predicts a scheduled task completion date based on the cumulative number of man-days and the task scale progress rate with addition of the estimated task scale and the estimated number of man-days for the next fixed period if the estimated productivity is greater than the latest actual productivity, or predicts a scheduled task completion date based on the cumulative number of man-days and the task scale progress rate with no addition of the estimated task scale and the estimated number of man-days for the next fixed period if the estimated productivity is smaller than the latest actual productivity.

9. A task progress management method using a task progress management device comprising: an entry section, a storage section for storing information entered in the entry section; a computation section for computing reference information related to a plan of a selected task using the information entered in the entry section or information stored in the storage section; a display section for displaying the information entered in the entry section and the computation results in the computation section; and a control section for executing write of information to the storage section, read of information from the storage section, and transfer of the computation results in the computation section to the display section, the method comprising the steps of:
(a) entering a task plan including a start date, a completion date and a total task scale of the selected task, task actual results and non-operating man-day information including holiday information in the entry section;
(b) computing the number of man-days available in a first period starting from termination of entry of information in the entry section, based on the task plan and the non-operating man-day information, in the computation section;
(c) computing the number of man-days available in a second period after the passing of the first period until the completion date of the selected task, based on the task plan and the non-operating man-day information, in the computation section; and
(d) estimating a reference task scale in the first period from a rate of the number of man-days available in the first period to the number of man-days available in the second period and the remaining task scale until termination of the selected task, in the computation section.

10. The method of claim 9, wherein a pattern of an operating man-day rate for weighting the number of operating man-days in each of periods into which the duration from the task start date to the task completion date is divided arbitrarily is written in the storage section,
the step (b) further comprises the step of correcting the number of man-days available in the first period using the pattern of the operating man-day rate, in the computation section,
the step (c) further comprises the step of correcting the number of man-days available in the second period using the pattern of the operating man-day rate, in the computation section, and
in the step (d), the corrected number of man-days available in the first period and the corrected number of man-days available in the second period are used.

11. The method of claim 9, wherein the result of multiplication of the total number of man-days by an arbitrarily set advancing rate is written in the storage section,
the step (b) further comprises the step of correcting the number of man-days available in the first period using the multiplication result, in the computation section,
the step (c) further comprises the step of correcting the number of man-days available in the second period using the multiplication result, in the computation section, and
in the step (d), the corrected number of man-days available in the first period and the corrected number of man-days available in the second period are used.

12. The method of claim 9, wherein there are a plurality of tasks of which the progress statuses are managed by the task progress management device, and
the control section selects the plurality of tasks in the order of the completion date, the earliest date first, before the steps (a) to (d).

13. A task progress management method using a task progress management device comprising: an entry section, a storage section for storing information entered in the entry section; a computation section for computing reference information related to a plan of a selected task using the information entered in the entry section or information stored in the storage section; a display section for displaying the information entered in the entry section and the computation results in the computation section; and a control section for executing write of information to the storage section, read of information from the storage section, and transfer of the computation results in the computation section to the display section, the method comprising the steps of:
(a) entering a task plan including a task category, a start date, a completion date, a total task scale and the total number of man-days of the selected task;
(b) entering task actual results of an individual including a task scale and the number of man-days completed every fixed period;
(c) writing a cumulative task scale and the cumulative number of man-days accumulated for each task category in the storage section with the entry of the task scale and the number of man-days completed every fixed period;
(d) computing productivity of the task plan calculated from (the total task scale)/(the total number of man-days), the maximum and minimum of productivity from the task scale and the number of man-days completed in each of fixed periods, the average of productivity from the cumulative task scale and the cumulative number of man-days, and latest actual productivity from the task scale and the number of man-days completed in the latest one of the fixed periods, in the computation section; and
(e) computing the number of man-days for the next fixed period using the computation results obtained in the step (d), in the computation section.

14. The method of claim 13, wherein in the step (d), the computation section further computes the first reference number of man-days from the productivity of the task plan and the planned task scale for the next fixed period, the second reference number of man-days from the latest actual productivity and the planned task scale for the next fixed period, the third reference number of man-days from the maximum of productivity and the planned task scale for the next fixed period, the fourth reference number of man-days from the minimum of productivity and the planned task scale for the next fixed period, and the fifth reference number of man-days from the average of productivity and the planned task scale for the next fixed period, and
the method further comprises the steps of:
(f) computing productivity data from the remaining task scale of the selected task and the number of man-days available until the completion date, and computing the standard number of man-days from the productivity data and the planned task scale for the next fixed period, in the computation section, and
(g) giving warning display different from normal display if any of the first reference number of man-days, the second reference number of man-days, the third reference number of man-days, the fourth reference number of man-days and the: fifth reference number of man-days is greater than the standard number of man-days.

15. A task progress management method using a task progress management device comprising: an entry section, a storage section for storing information entered in the entry section; a computation section for computing reference information related to a plan of a selected task using the information entered in the entry section or information stored in the storage section; a display section for displaying the information entered in the entry section and the computation results in the computation section; and a control section for executing write of information to the storage section, read of information from the storage section, and transfer of the computation results in the computation section to the display section, the method comprising the steps of:
(a) entering a task plan including a start date, a completion date, a total task scale and the total number of man-days of the selected task and non-operating man-day information including holiday information in the entry section;
(b) entering task actual results of an individual including the task scale and the number of man-days completed every fixed period;
(c) computing a task scale progress rate from a cumulative task scale of the selected task and the total task scale, in the computation section; and
(d) calculating the number of man-days required until completion of the selected task from the cumulative number of man-days of the selected task and the task scale progress rate and predicting a scheduled completion date of the task based on the computation result, in the computation section.

16. The method of claim 15, further comprising the steps of:
(e) computing estimated productivity from an estimated task scale and the estimated number of man-days for the next fixed period and computing latest actual productivity from a task scale and the number of man-days in the latest fixed period, in computation section,
wherein in the step (d), the computation section predicts a scheduled task completion date based on the cumulative number of man-days and the task scale progress rate with addition of the estimated task scale and the estimated number of man-days for the next fixed period if the estimated productivity is greater than the latest actual productivity, or predicts a scheduled task completion date based on the cumulative number of man-days and the task scale progress rate with no addition of the estimated task scale and the estimated number of man-days for the next fixed period if the estimated productivity is smaller than the latest actual productivity.

17. A program for enabling a computer to execute a function of a task progress management device comprising: an entry section, a storage section for storing information entered in the entry section; a computation section for computing reference information related to a plan of a selected task using the information entered in the entry section or information stored in the storage section; a display section for displaying the information entered in the entry section and the computation results in the computation section; and a control section for executing write of information to the storage section, read of information from the storage section, and transfer of the computation results in the computation section to the display section, the function to executed by the computer comprising the steps of:
(a) entering a task plan including a start date, a completion date and a total task scale of the selected task, task actual results and non-operating man-day information including holiday information in the entry section;
(b) computing the number of man-days available in a first period starting from termination of entry of information in the entry section based on the task plan and the non-operating man-day information;
(c) computing the number of man-days available in a second period after the passing of the first period until the completion date of the selected task, based on the task plan and the non-operating man-day information; and
(d) estimating a reference task scale in the first period from a rate of the number of man-days available in the first period to the number of man-days available in the second period and the remaining task scale until termination of the selected task.

18. The program of claim 17, wherein a pattern of an operating man-day rate for weighting the number of operating man-days in each of periods into which the duration from the task start date to the task completion date is divided arbitrarily is written in the storage section,
the step (b) further comprises the step of correcting the number of man-days available in the first period using the pattern of the operating man-day rate,
the step (c) further comprises the step of correcting the number of man-days available in the second period using the pattern of the operating man-day rate, and
in the step (d), the corrected number of man-days available in the first period and the corrected number of man-days available in the second period are used.

19. The program of claim 17, wherein the result of multiplication of the total number of man-days by an arbitrarily set advancing rate is written in the storage section,
the step (b) further comprises the step of correcting the number of man-days available in the first period using the multiplication result,
the step (c) further comprises the step of correcting the number of man-days available in the second period using the multiplication result, and
in the step (d), the corrected number of man-days available in the first period and the corrected number of man-days available in the second period are used.

20. The program of claim 17, wherein there are a plurality of tasks managed by a computer, and
the plurality of tasks are selected in the order of the completion date, the earliest date first, before the steps (a) to (d).

21. A program for enabling a computer to execute a function of a task progress management device comprising: an entry section, a storage section for storing information entered in the entry section; a computation section for computing reference information related to a plan of a selected task using the information entered in the entry section or information stored in the storage section; a display section for displaying the information entered in the entry section and the computation results in the computation section; and a control section for executing write of information to the storage section, read of information from the storage section, and transfer of the computation results in the computation section to the display section, the function to executed by the computer comprising the steps of:
(a) entering a task plan including a task category, a start date, a completion date, a total task scale and the total number of man-days of the selected task;
(b) entering task actual results of an individual including a task scale and the number of man-days completed every fixed period;
(c) writing a cumulative task scale and the cumulative number of man-days accumulated for each task category in the storage section according to the entry of the task scale and the number of man-days completed every fixed period;
(d) computing productivity of the task plan calculated from (the total task scale)/(the total number of man-days), the maximum and minimum of productivity from the task scale and the number of man-days completed in each of fixed periods, the average of productivity from the cumulative task scale and the cumulative number of man-days, and latest actual productivity from the task scale and the number of man-days completed in the latest one of the fixed periods; and
(e) computing the number of man-days for the next fixed period using the computation results obtained in the step (d).

22. The program of claim 21, wherein in the step (d), the computer is made to further compute the first reference number of man-days from the productivity of the task plan and the planned task scale for the next fixed period, the second reference number of man-days from the latest actual productivity and the planned task scale for the next fixed period, the third reference number of man-days from the maximum of productivity and the planned task scale for the next fixed period, the fourth reference number of man-days from the minimum of productivity and the planned task scale for the next fixed period, and the fifth reference number of man-days from the average of productivity and the planned task scale for the next fixed period, and
the function further comprises the steps of:
(f) computing productivity data from the remaining task scale of the selected task and the number of man-days available until the completion date, and computing the standard number of man-days from the productivity data and the planned task scale for the next fixed period, and
(g) giving warning display different from normal display if any of the first reference number of man-days, the second reference number of man-days, the third reference number of man-days, the fourth reference number of man-days and the fifth reference number of man-days is greater than the standard number of man-days.

23. A program enabling a computer to execute a function of a task progress management device comprising: an entry section, a storage section for storing information entered in the entry section; a computation section for computing reference information related to a plan of a selected task using the information entered in the entry section or information stored in the storage section; a display section for displaying the information entered in the entry section and the computation results in the computation section; and a control section for executing write of information to the storage section, read of information from the storage section, and transfer of the computation results in the computation section to the display section, the function to be executed by the computer comprising the steps of:
(a) entering a task plan including a start date, a completion date, a total task scale and the total number of man-days of the selected task and non-operating man-day information including holiday information in the entry section;
(b) entering task actual results of an individual including the task scale and the number of man-days completed every fixed period;
(c) computing a task scale progress rate from a cumulative task scale of the selected task and the total task scale; and
(d) calculating the number of man-days required until completion of the selected task from the cumulative number of man-days of the selected task and the task scale progress rate and predicting a scheduled completion date of the task based on: the computation result.

24. The program of claim 23, wherein the function further comprises the step of:
(e) computing an estimated task scale, the estimated number of man-days and estimated productivity for the next fixed period and computing latest actual productivity from a task scale and the number of man-days in the latest fixed period, and
in the step (d), a scheduled task completion date is predicted based on the cumulative number of man-days and the task scale progress rate with addition of the estimated task scale and the estimated number of man-days for the next fixed period if the estimated productivity is greater than the latest actual productivity, or a scheduled task completion date is predicted based on the cumulative number of man-days and the task scale progress rate with no addition of the estimated task scale and the estimated number of man-days for the next fixed period if the estimated productivity is smaller than the latest actual productivity.
